(19) United States
(12) Patent Application Publication
(10) Pub. No.: US 2025/0347907 A1
(43) Pub. Date: Nov. 13, 2025

(54) HIGHLY TRANSMISSIVE EYEPIECE ARCHITECTURE

(71) Applicant: Magic Leap, Inc., Plantation, FL (US)

(72) Inventors: Chinmay KHANDEKAR, Sunnyvale, CA (US); Robert D. TEKOLSTE, Boulder, CO (US); Mohammadsadegh FARAJI-DANA, Sunnyvale, CA (US); Vikramjit SINGH, Pflugerville, TX (US)

(21) Appl. No.: 18/879,993

(22) PCT Filed: Jul. 7, 2023
(86) PCT No.: PCT/US2023/027172

§ 371 Date: Dec. 30, 2024

Related U.S. Application Data
(60) Provisional application No. 63/359,194, filed on Jul. 7, 2022.

(51) Int. Cl. G02B 25/00; G02B 5/18; G02B 27/42

(52) U.S. Cl. CPC G02B 25/001; G02B 5/18; G02B 27/4205

(57) ABSTRACT

An eyepiece includes a substrate, an input coupling grating on a first side of the substrate, and a morphed grating comprising characteristics of both a primary grating and a secondary grating on at least the first side of the substrate. The primary grating and the secondary grating may differ in pitch, orientation, and dimensions.

### CLAIM OF PRIORITY

This application claims priority under 35 USC § 119(e) to U.S. Patent Application No. 63/359,194, filed on Jul. 7, 2022, the entire contents of which are hereby incorporated by reference.

### TECHNICAL FIELD

The implementations described herein generally relate to a highly transmissive eyepiece architecture.

### BACKGROUND

The waveguides used for an augmented reality eyepiece display have high refractive indices associated with a surface relief pattern and substrate, both of which are criteria for achieving a large field-of-view with good image brightness and uniformity of digital content for display.

### SUMMARY

This disclosure generally describes methods and systems for highly transmissive eyepiece architecture with additional, morphed, or stacked secondary gratings with primary gratings to improve transmission and back-reflection characteristics of an eyepiece without compromising display performance. The secondary gratings can have a smaller pitch with respect to the primary gratings. The primary and secondary gratings can be one-dimensional (1D) or two-dimensional (2D).

As described herein, when multiple 1D or 2D gratings of small pitch, e.g., lattice periodicity of the gratings, are stacked on top of the primary diffraction gratings used for display of digital content, a transmission to reflection ratio of an eyepiece can increase from 5-10×, e.g., the transmission coefficient increases, the back-reflection coefficient decreases, or both.

Particular implementations of the subject matter described in this specification can be implemented so as to realize one or more of the following advantages. First, stacking of selected short-pitch gratings, using morphed gratings, and particular combinations of diffractive optical elements can help to improve the see-through transmission and back-reflection performance without compromising the display performance. Second, in some cases, the display performance can further improve with gratings as described herein.

The details of one or more implementations of the subject matter of this specification are set forth in the Detailed Description, the Claims, and the accompanying drawings. Other features, aspects, and advantages of the subject matter will become apparent to those of ordinary skill in the art from the Detailed Description, the Claims, and the accompanying drawings.

### BRIEF DESCRIPTION OF THE DRAWINGS

FIGS. 1A-1C are illustrations representing photographs of views taken through first to third augmented reality headsets, respectively, according to an implementation of the present disclosure.

FIG. 1D is an illustration of a photograph of the laboratory setting, according to an implementation of the present disclosure, according to an implementation of the present disclosure.

FIG. 2A depicts a cross-sectional view of an eyepiece, according to an implementation of the present disclosure.

FIG. 2B depicts a momentum space diagram of light propagating in the eyepiece of FIG. 2A, according to an implementation of the present disclosure.

FIGS. 2C and 2D depict plan views of the front and back sides, respectively, of the eyepiece of FIG. 2A, according to an implementation of the present disclosure.

FIGS. 3A and 3B depict two examples of architectures and supporting virtual images with large field-of-views, according to an implementation of the present disclosure.

FIG. 3C includes a key for FIGS. 3A and 3B, according to an implementation of the present disclosure.

FIGS. 4A-4D depict plan views of examples of eyepieces incorporating different optical elements, according to an implementation of the present disclosure.

FIGS. 4E-4G are simulated plots of back-reflection for the first through third eyepieces discussed in relation to FIGS. 4A-4D, according to an implementation of the present disclosure.

FIGS. 5A-5G depict cross-sectional views of examples of architectures including morphed gratings, according to an implementation of the present disclosure.

FIG. 6 is a perspective view of the one of the architectures from FIG. 5, according to an implementation of the present disclosure.

FIGS. 7A-7B depict plots representing the effect of different morphed gratings on the momentum of light traveling in the eyepiece, according to an implementation of the present disclosure.

FIG. 8 depicts a plot representing the effect of different morphed gratings on the momentum of light traveling in the eyepiece, according to an implementation of the present disclosure.

FIGS. 9A-9F depict plots representing the effect of different morphed gratings on the momentum of light traveling in the eyepiece, according to an implementation of the present disclosure.

FIG. 10 depicts a plot of the simulated transmission profiles of the eyepieces from FIGS. 9A-9F versus wavelength, according to an implementation of the present disclosure.

FIGS. 11A and 11B depict plots of the simulated reflectance profiles of the eyepieces from FIGS. 9A-9F versus wavelength for transverse-magnetic (TM) and transverse-electric (TE) polarized light, respectively, according to an implementation of the present disclosure.

FIG. 12 depicts a plot of the transmission versus wavelength for eyepieces with and without a recycler for both s- and p-polarized light at normal incidence, according to an implementation of the present disclosure.

FIGS. 13A-13F depict the far-field efficiency distribution patterns for a large field-of-view associated with the eyepieces from FIGS. 9A-9F, respectively, according to an implementation of the present disclosure.

FIGS. 13G and 13H depict virtual image uniformities for control and morphed grating eyepieces, respectively, according to an implementation of the present disclosure.

FIGS. 14A-14F depict schematics of an example of a fabrication process for a morphed grating, according to an implementation of the present disclosure.

FIGS. 15A-15F depict schematics of an example of a fabrication process, using an intermediate masking layer, for a morphed grating, according to an implementation of the present disclosure.

FIGS. 16A-16F depict schematics of an example of a fabrication process for a morphed grating with a graded primary grading, according to an implementation of the present disclosure.

FIGS. 17A-17F depict schematics of an example of a fabrication process for a morphed grating where both the primary and secondary gratings are graded, according to an implementation of the present disclosure.

FIGS. 18A-18F depict schematics of an example of a fabrication process for a morphed grating where the primary grating is a sawtooth grating, according to an implementation of the present disclosure.

FIG. 19A depicts an example of an eyepiece including a secondary grating, according to an implementation of the present disclosure.

FIG. 19B depicts an example of stacked gratings, according to an implementation of the present disclosure.

FIG. 20A depicts an example of a stacked grating, according to an implementation of the present disclosure. FIG. 20B depicts a plot with the transmission profiles of the stacked grating from FIG. 20A for five versions of the second index of refraction as a function of wavelength, according to an implementation of the present disclosure.

Like reference numbers and designations in the various drawings indicate like elements.

### DETAILED DESCRIPTION

The following detailed description describes highly transmissive eyepiece architecture, and is presented to enable any person skilled in the art to make and use the disclosed subject matter in the context of one or more particular implementations. Various modifications, alterations, and permutations of the disclosed implementations can be made and will be readily apparent to those of ordinary skill in the art, and the general principles defined can be applied to other implementations and applications, without departing from the scope of the present disclosure. In some instances, one or more technical details that are unnecessary to obtain an understanding of the described subject matter and that are within the skill of one of ordinary skill in the art may be omitted so as to not obscure one or more described implementations. The present disclosure is not intended to be limited to the described or illustrated implementations, but to be accorded the widest scope consistent with the described principles and features.

A single waveguide with a large refractive index or a stack of multiple waveguides with large refractive indices can have poor see-through transmission and noticeable back-reflection. The low transmission to reflection ratio can make such eyepieces less desirable for use with or without virtual content.

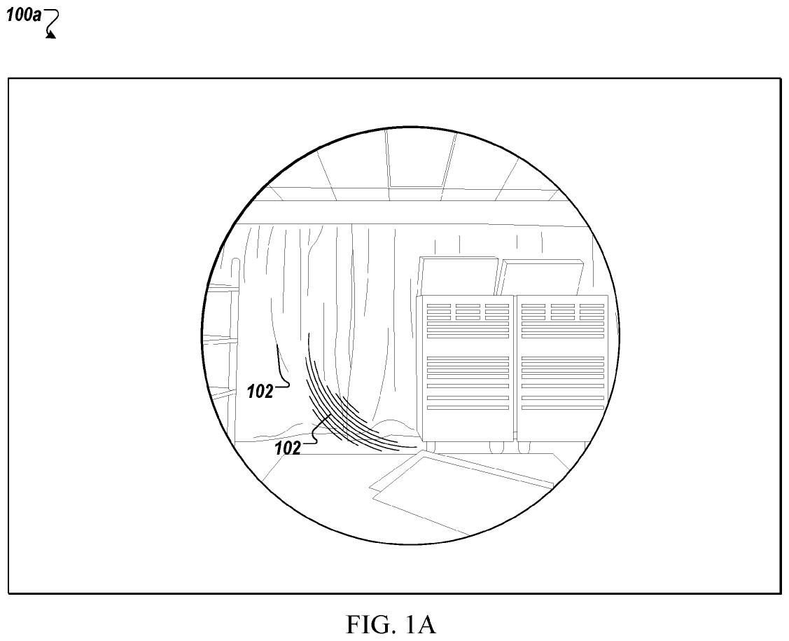

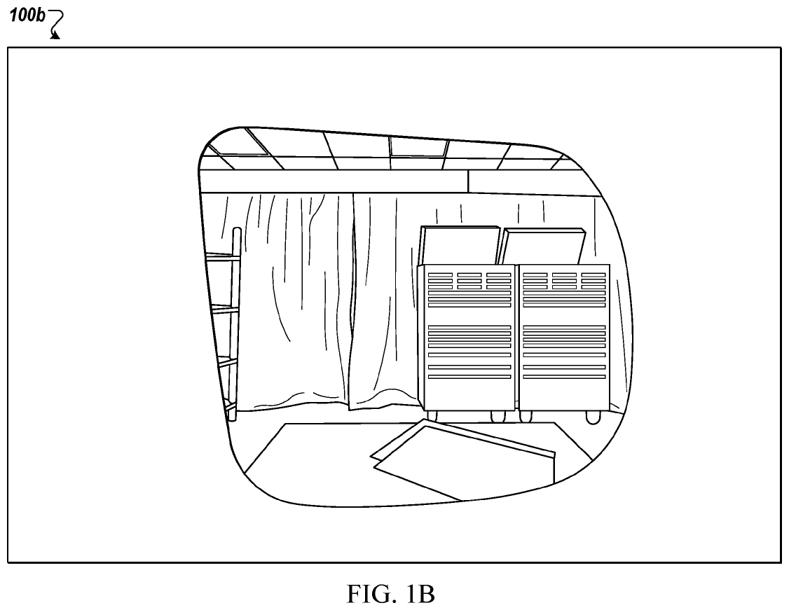

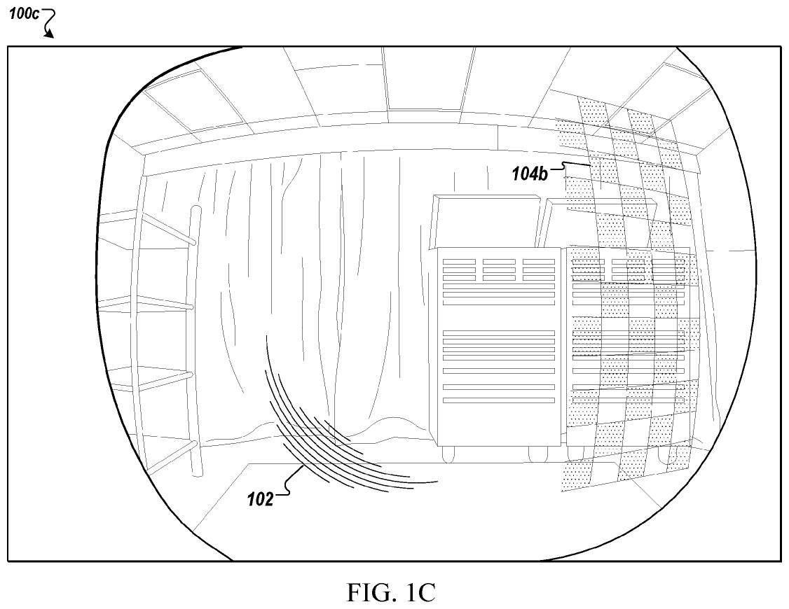

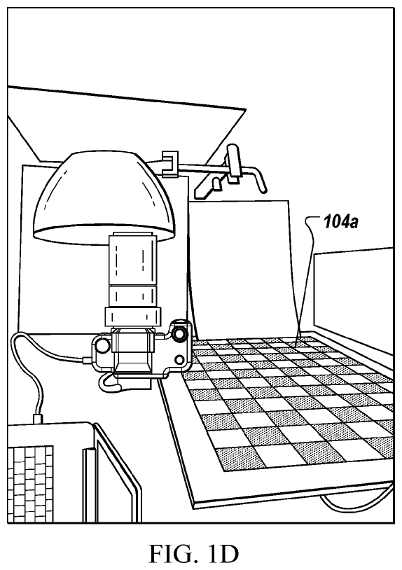

FIGS. 1A-1C are illustrations 100a-100c representing photographs of views taken through first to third headsets, respectively, according to an implementation of the present disclosure. The first headset view illustrated in FIG. 1A includes a stack of high-index waveguides with an EPE. The second Headset view illustrated in FIG. 1B has a hollow frame, e.g., no waveguides, in the eyepiece. The third Headset is similar to the first Headset, but has a different form factor.

FIG. 1D is an illustration 100d of a photograph of the laboratory setting, e.g., a room with a checkerboard pattern placed behind the first through third Headsets, used to take FIG. 1C.

As can be seen in FIGS. 1A and 1C, although high index waveguides can lead to an expanded field-of-view (FOV), using high-index waveguides in an eyepiece of an augmented reality headset can pose problems. First, high-index waveguides can reduce transmission of light from a “real scene” being observed by a user. Comparing FIGS. 1A and 1B, FIG. 1A appears dimmer, as the high-index waveguides in the eyepiece of the first Headset reduces transmission of light from the “real world,” e.g., the scene onto which augmented reality imagery is added. For example, the first Headset can have a light transmission rate of 60 to 65% or less.

Second, back-reflection and rainbow artifacts can obstruct a user's view. As can be seen in both FIGS. 1A and 1C, rainbow flares 102 originating from the light projection system appear in the photographs, though they do not in FIG. 1B. Further, the checkerboard 104a of FIG. 1D, which is behind the third Headset, appears in FIG. 1C as a back reflection 104b. For example, the coefficient of reflection of light incident on the waveguide stack at an angle between 0 to 30° can be about 30%. Back reflection can be worse in a portion of the FOV closer to the user's temple than to the user's nose, as the acceptance angle is greater for the region near the temple compared to the region near the nose due to the presence of the user's face.

Using a subwavelength 1D or 2D grating, e.g., having a pitch or periodicity smaller than the wavelength of incident light, can reduce the occurrence of back reflection when light encounters a high-index material coming from a low-index vacuum or air. However, adding an additional, e.g., secondary, grating for reducing back reflection can negatively affect the display performance of the eyepiece. The present disclosure presents eyepieces with primary and secondary gratings configured to reduce back-reflection, increase transmission, or both without negatively affecting the augmented reality display.

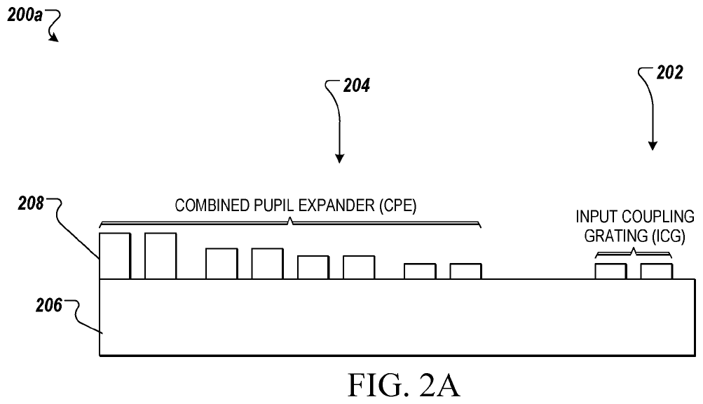

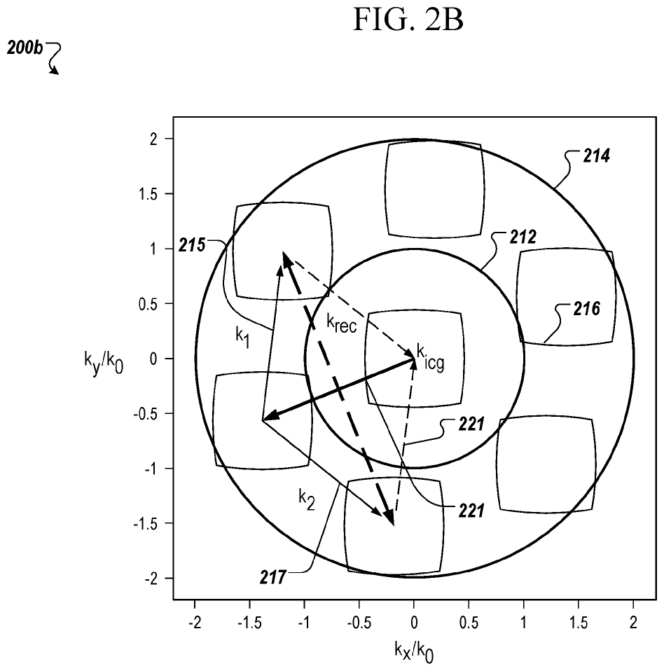

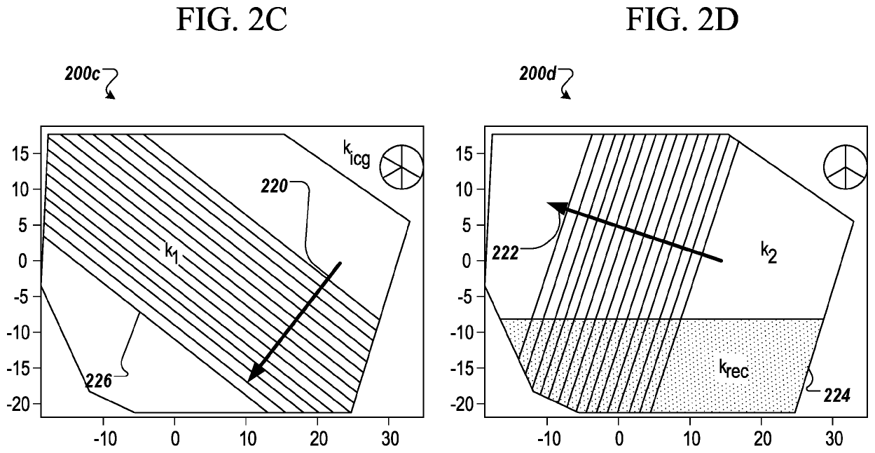

FIG. 2A depicts a cross-sectional view of an eyepiece 200a, according to an implementation of the present disclosure. The eyepiece 200a includes an input coupling grating (ICG) 202, a primary grating 204, and a substrate 206. In this disclosure, primary gratings refer to exit pupil expanders (EPEs), orthogonal pupil expanders (OPEs), and combined pupil expanders (CPEs).

The ICG 202 couples light from a projector into the substrate 206, which can have a high index of refraction, e.g., n≥2. The ICG 202 couples the light in at such an angle that the in-coupled light travels by total internal reflection (TIR) within the substrate 206.

The primary grating 204 is graded, e.g., the height of each row 208 gradually increases, from right to left, from a first value to a second value. While the middle portion of the primary grating is graded, the ends can have a constant height equal to the first and second value, respectively. In some implementations, the shape of the primary grating 204 is a binary square-ridge.

FIG. 2B depicts a momentum space diagram 200b of light propagating in the eyepiece 200 of FIG. 2A, according to an implementation of the present disclosure. The parameters of the eyepiece 200a, e.g., index of refraction of the substrate 206 and pitch of the primary grating, determine permissible wave vectors, e.g., k-vectors, of light propagating through the substrate 206. For example, the linear momentum of light corresponding to the amplitude of a phase wave front (˜e^{ik·r-iωt}) depends on an index of refraction of a material through which it propagates, e.g., the momentum is proportional to the index of refraction.

As another example, the magnitude of a wave vector representing the momentum change from a grating is inversely proportional to the pitch of the grating. In FIG. 2B, the inner circle 212 represents the momentum of light for all angles of incidence, e.g., around the 360° of the circle, for light traveling in material with n=1, e.g., air. The outer circle 214 represents the momentum of light for all physically possible angles for light traveling in a material with n=2, e.g., the substrate 206.

Barrel-shaped boxes represent the FOV 216 as it travels through the substrate 206 and is in- and out-coupled. The momentum of light changes when in-coupled by the ICG 202 and interacting with the primary grating 204. For example, being in-coupled into the substrate 206 increases the momentum of a light ray in the FOV originally centered within the inner circle, e.g., the FOV being centered on kₓ,k_{y}=(0,0), such that it resides in the annulus between the inner and outer circles 212 and 214. Arrow 218 represents the change of momentum, which is proportional to k_{icg}, due to in-coupling.

As light propagates using TIR in the substrate 206, the light periodically interacts with the primary grating 204. The parameters of the primary grating 204 determine how the momentum of the light will change when it encounters the primary grating 204. For example, the pitch and orientation can determine the magnitude and direction of a k-vector k₁ 215 representing the change. Further, light can travel by integer multiples of k₁, e.g., higher orders and negative values.

In some implementations, the primary grating 204 has two layers, e.g., a diffraction grating on each side of the substrate 206 with different periodicity and pitch. Accordingly, for a two-layered primary grating, there is an additional k-vector, e.g., k₂ 217, also determined by the pitch and orientation that represents the change in the momentum of in-coupled light.

In some implementations, the grating of the primary grating 204 is 2D, e.g., formed by discrete pillars rather than continuous rows. When the grating is 2D, an additional k-vector k₂ 217 corresponds to a different change in the momentum of propagating light. When one side of the substrate has a 2D primary grating 204, the other side of the substrate can be patterned with an antireflective (AR) nano-pattern or multilayered AR film coating to reduce reflection loss of “real world” light to compensate for not having a primary grating on each side.

As will be discussed later, the antireflective nano-pattern can also affect the momentum of the light propagating in the substrate. For anti-reflective (AR) coatings made of short-pitch (shorter than wavelength) diffractive grating structures, anti-reflection characteristics can be achieved by stacking and/or morphing such gratings with the primary diffractive gratings of the eyepiece. The associated grating vector can be selected to avoid interference with the functionality of primary diffractive gratings described above.

In some implementations, a single eyepiece combines both multilayered primary gratings and 2D primary gratings. For example, regions of an eyepiece close to the temple of a user can receive higher intensity light over greater angular range. Accordingly, the regions of the eyepiece close to the temple can have a 2D CPE on one side and a 1D diffractive structure on the other side. The rest of the eyepiece, the area closer to the user's pupil and nasal side, can have 1D diffractive structures on both sides in order to have high optical efficiency near the pupil of the user.

By translating from the initial FOV within the inner circle 212 to various positions within the annulus between the inner and outer circles 212 and 214, the launched light, e.g., light projected into the ICG 202, spreads over a larger area for people expansion. The primary grating 204 out-couples light as well, so that the increased FOV reaches a user.

The dashed arrows 219 and 221 represent the k-vectors k₂ and k₁, respectively, of the primary grating 204 out coupling the light to the pupil of the user, allowing the user to view digital content. In some implementations, out-coupled light propagates at an angle equal to the angle of incidence for light from the projector incident on the ICG 202.

FIGS. 2C and 2D depict plan views 200c and 200d of the front and back sides, respectively, of the eyepiece 200a of FIG. 2A, according to an implementation of the present disclosure. The arrows 220 and 222 depict the directions of gradation, e.g., in which direction the height of the rows of diffraction gratings on each side of the substrate change. For example, the gradation can have 16 zones 226 of differing height. The plan view 200c shows a first side of the eyepiece 200 with a diffraction grating characterized by k-vector k₁. The plan view 200d shows a second side of the eyepiece 200a with a diffraction grating characterized by k-vector k₂. The second side of the eyepiece also includes a recycler 224, whose function is to “recycle” light back into the eyepiece when it has reached a location in momentum space where the light would otherwise leave the FOV after another interaction with the primary grating 204. In some implementations, the recycler 224 is a diffraction grating with a pitch and orientation determined by the parameters of the diffraction gratings making up the primary grating 204. For example, the k-vector of the recycler k_{rec} can be equal to the difference between k₁ and k₂. The pitch of the recycler 224 can be half of that of the primary grating. In some implementations, the sum of k_{icg}, k₁, and k₂ is zero, which ensures that light will exit at the same angle it entered the ICG 202 from the projector.

### 1.0 Case 1: Additional Optical Elements

A first approach is to supplement primary gratings with secondary gratings as follows.

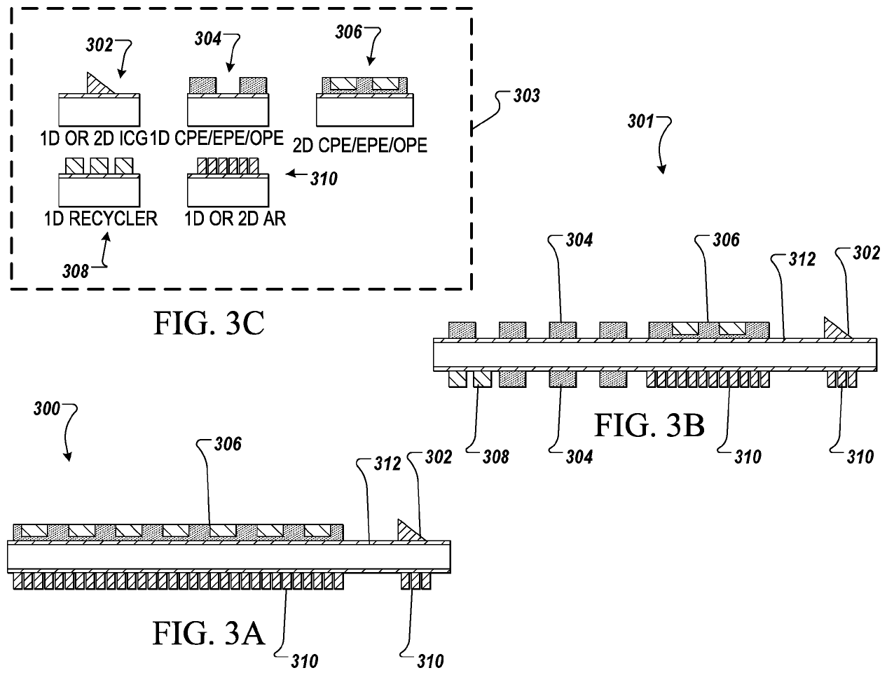

FIGS. 3A and 3B depict two examples of architectures 300 and 301 supporting virtual images with large FoVs, according to an implementation of the present disclosure. FIG. 3C includes a key 303, explaining what symbols represent each type of optical element in the architectures 300 and 301. The key 303 includes 1D or 2D ICGs 302 represented by right triangles, 1D CPEs/OPEs/EPEs 304 represented by square ridges, 2D CPEs/OPEs/EPEs 306 represented by wide ridges with the coating between each ridge, 1D recyclers 308 represented by square ridges with diagonal markings, and 1D or 2D antireflective gratings 310 represented by narrow ridges. Features in key 303 independently can be 1D binary lines and spaces or other 1D structures or 2D structures, such as holes and pillars or other 2D structures.

For example, architecture 300 is an eyepiece with a 2D CPE/OPE/EPE 306, e.g., multilayered CPE, with at least two wave vectors characterizing the CPE/OPE/EPE. On the side of the substrate 312 opposite to the CPE/OPE/EPE 306 is an antireflective grating 310, which is opposite both the CPE/OPE/EPE 306 and the ICG 302. In some implementations, architecture 300 keeps the temple side, e.g., side with the AR grating 310, of the substrate 312, e.g., transparent waveguide, less reflective compared to having a dual-sided, e.g., on both sides of the substrate 312, 1D diffractive pattern, which can lead to higher reflection for world light incident angles from 0 to 60°.

As another example, architecture 301 includes a combination of 1D and 2D CPEs/OPEs/EPEs 304 and 306. On a first side of the substrate 312 is an ICG 302, a 2D CPE/OPE/EPE 306, and a 1D CPE/OPE/EPE 304. The second side of the substrate 312, opposite to the first side, includes an antireflective grating 310 below the ICG 302 and the 2D CPE/OPE/EPE 306, a 1D CPE/OPE/EPE 304 below the a 1D CPE/OPE/EPE 304 on the first side, and a 1D recycler partially below a portion of the a 1D CPE/OPE/EPE 304 on the first side.

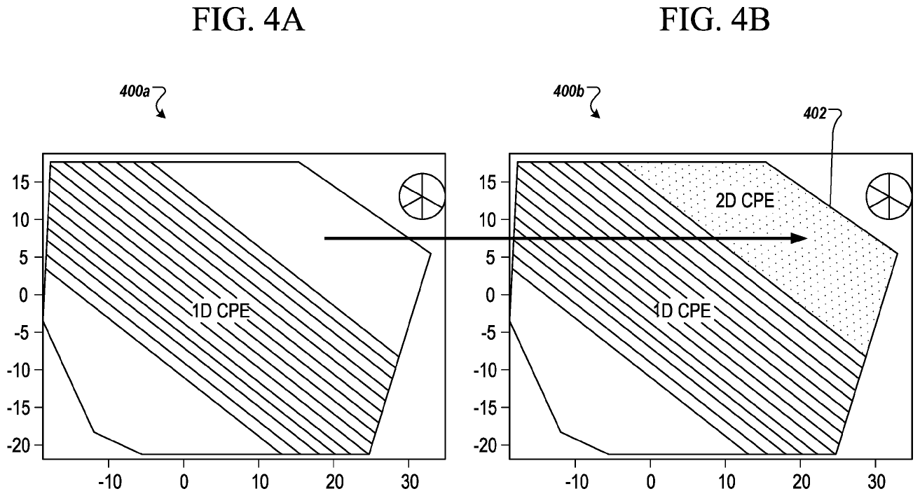

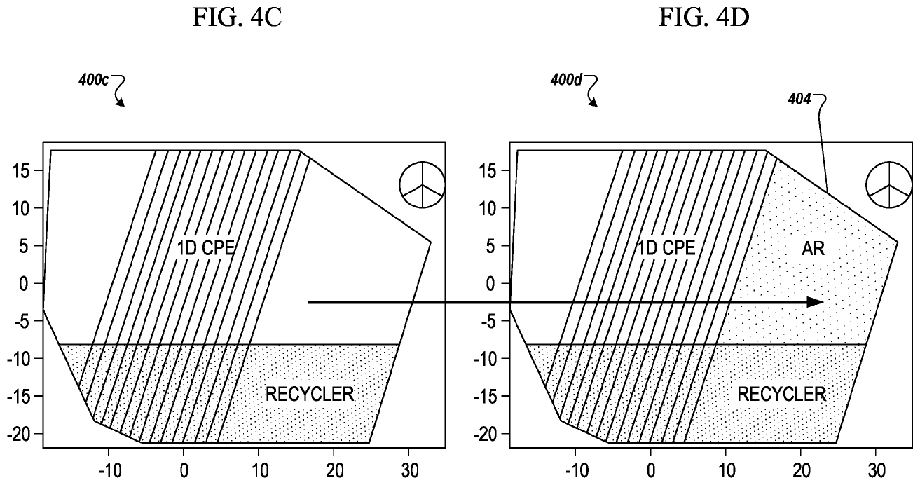

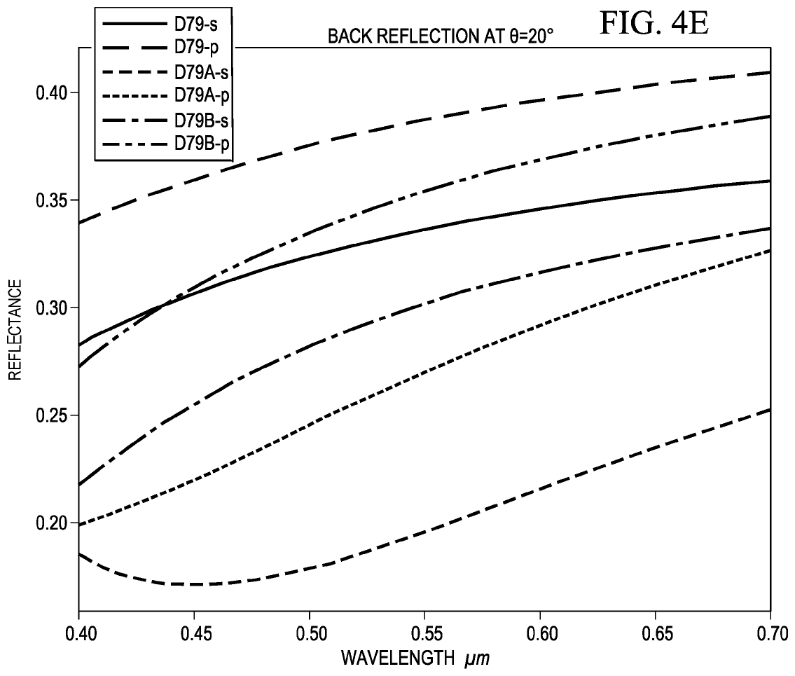

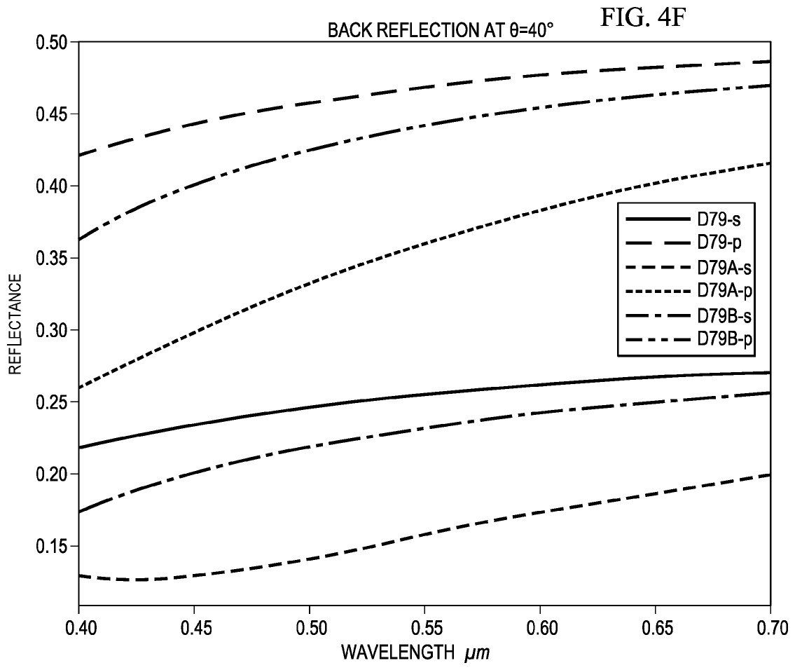

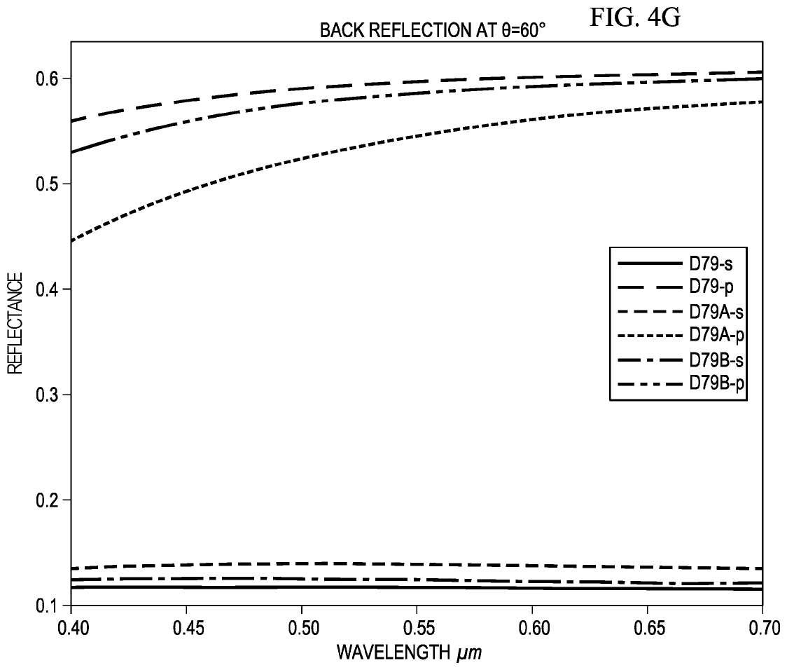

FIGS. 4A-4D depict plan views 400a-400d of examples of eyepieces incorporating different optical elements, according to an implementation of the present disclosure. Plan views 400a and 400b are the world-side, e.g., side closer to a scene viewed by a user, of the eyepiece, and plan views 400c and 400d are the eye-side, e.g., side closer to the eye of the user.

FIGS. 4A and 4C respectively depict the world-side and eye-side of a first eyepiece “D79” with a graded, 1D CPE on the world-side and a graded, 1D CPE and recycler on the eye-side. FIGS. 4B and 4D respectively depict the world-side and eye-side of a second eyepiece “D79A,” where a 2D CPE replaces a portion 402 of the 1D CPE on the world side, and an AR grating replaces a portion 404 of the 1D CPE on the eye side. Although not depicted, a third eyepiece “D79B” can include portions 402 and 404 each replaced with 1D gratings up to square ridges, e.g., half-pitch gratings.

FIGS. 4E-4G are simulated plots 400e-400g of back-reflection versus the wavelength for the first to third eyepieces, e.g., D79, D79A, and D79B, discussed in relation to FIGS. 4A-4D. Plots 400e-400g include simulated for both s-and p-polarized light for light incident at 20°, 40°, and 60°, respectively.

As can be seen by FIGS. 4E-4G, the reflection coefficient for p-polarized light is generally greater than its s-polarized light counterpart. In general, the reflection coefficient increases or plateaus as the wavelength increases.

FIGS. 4E-4G demonstrate that the reflection coefficients as a function of wavelength have a dependence on the angle of incidence, according to an implementation of the present disclosure. Note that the y-axis of each of FIGS. 4E-4G scales differently. For p-polarized light, the reflection coefficient increases as the angle of incidence increases from 20° to 60°, while the reflection coefficient decreases as the angle of incidence increases from 20° to 60° for s-polarized light.

Additionally, the reflection coefficient is generally the lowest for the second eyepiece D79A and greatest for the first eyepiece D79, suggesting that the architecture of the second eyepiece would best reduce undesired back-reflection of these three eyepieces. However, the associated AR grating vectors of the optical elements of the second eyepiece D79A can interfere with the functionality of the CPE, making the design and parameters of the AR gratings important.

### 2.0 Case 2: Combinatory Morphed Grating Optical Elements

A second approach is to use morphed gratings, e.g., gratings having characteristics of both primary and second gratings.

FIGS. 5A-5G depict cross-sectional views 500a-500g of examples of architectures 500a, 500b, 500c, 500d, 500e, 500f, and 500g including morphed gratings, according to an implementation of the present disclosure. The same key 303 from FIG. 3 applies to the architectures in FIGS. 5A-5G. Note labels 602 and 604, which have been included to provide further reference and perspective to descriptions in FIG. 6.

In some implementations, such as architectures 500a, 500b, 500c, 500d, 500e, 500f, and 500g, an eyepiece area in front of the user's eye can include, on each side, a primary grating that includes CPE/EPE/OPE features, e.g., 1D rows or 2D holes and/or pillars combined with 1D or 2D AR elements. In some implementations, such as architecture 500f, an eyepiece area in front of the user's eye can include a primary grating that includes, on each side, CPE/EPE/OPE features, e.g., 1D rows or 2D holes and/or pillars combined with 1D recycler elements. Combining the CPE/EPE/OPE features with recycler elements on each side can increase the transmission to reflection ratio and other virtual image key point indicators, such as improved image uniformity, compared to architectures lacking morphed optical elements.

Although the cross-sectional view of architecture 500b depicts repeating patterns of both primary and secondary gratings 602 and 604 (making the primary and secondary gratings appear aligned), the primary and secondary gratings 602 and 604 can be oriented at a nonzero angle relative to each other.

FIG. 6 is a perspective view 600 of the architecture 500b from FIG. 5, according to an implementation of the present disclosure. The architecture 504 includes a primary grating 602 (marked in FIG. 5) and a secondary grating 606 (marked in FIG. 5). As visible from the perspective view 600, the primary and secondary gratings 602 and 604 can have different orientations and pitches. For example, primary grating 602 is oriented perpendicular to the direction of each row of the primary grating 602, e.g., along arrow 610, and has a pitch indicated by arrow 612. The secondary grating 604 is oriented perpendicular to the direction of each row of the secondary grating 604, e.g., along arrow 614, and has a pitch indicated by bracket 616. Accordingly, the other architectures can also include primary and secondary gratings oriented at nonzero angles relative toward each other.

FIG. 6 illustrates that a morphed grating can have characteristics of both a primary grating 602 in the secondary grating 604, e.g., two orientations and two pitches characterizing the morphed grating. In other words, neither the characteristics of only the primary or secondary grating can fully capture the shape of the morphed grating.

Morphing diffraction gratings introduces some challenges in an augmented reality eyepiece. For example, depending on the parameters of a morphed antireflective grating, the user can see multiple shifted copies of the same digital content.

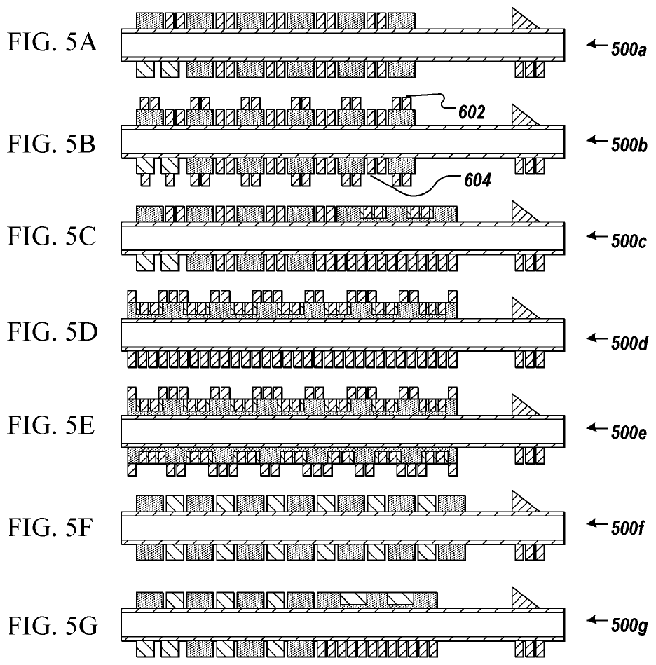

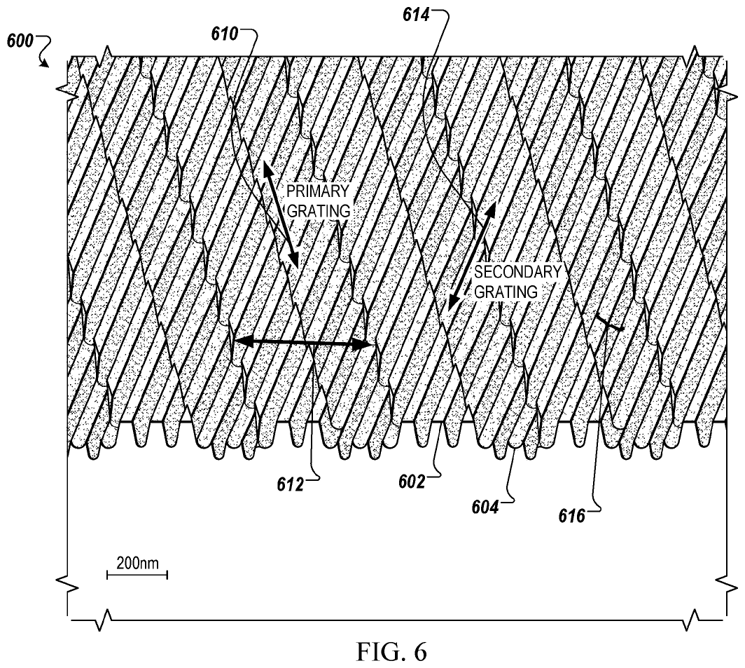

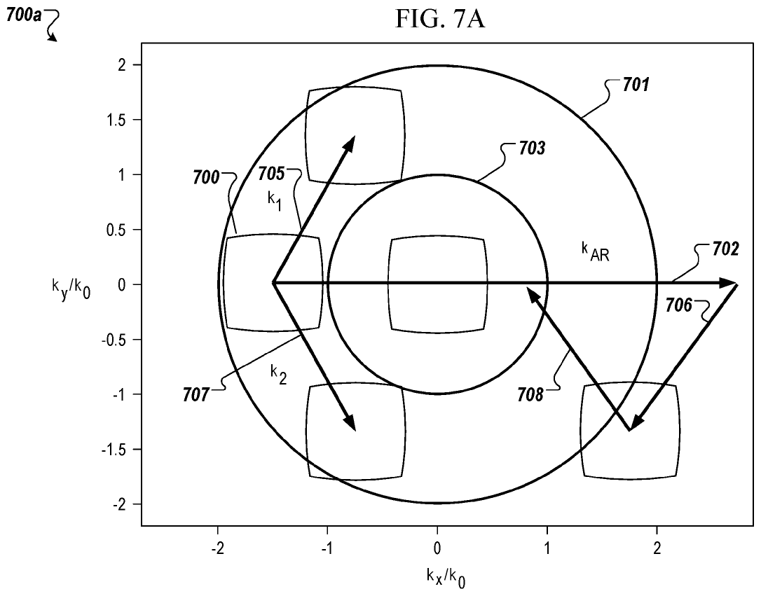

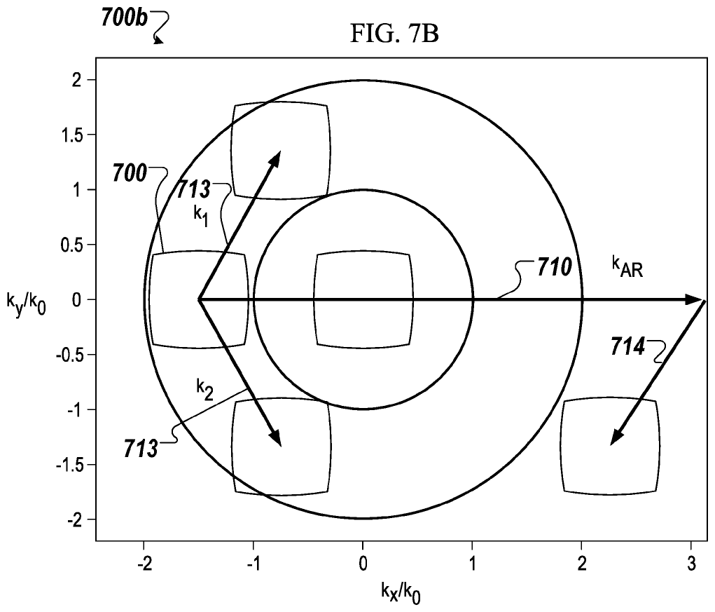

FIGS. 7A-7B depict plots 700a-700b representing the effect of morphed gratings on the momentum of light traveling in the eyepiece, according to an implementation of the present disclosure. In both plots 700a and 700b, the secondary grating, e.g., an AR grating, corresponds to a k-vector along the x-axis. The magnitude of the k-vector, however, is different. In plot 700a, the k-vector K_{AR} 702 of the secondary grating translates the FOV 700 from the annulus between inner and outer circles 701 and 703 outside of the outer circle 701. However, a negative version of k-vector k₁ 705, e.g., k-vector 706, translates the FOV to be partially within the inner circle 703. Then a negative version of k-vector k₂ 707, e.g., k-vector 708, translates the FOV to lie partially inside and outside of the inner circle 703, which causes different versions of the expanded FOV to out-couple to the user's eye at different angles, since some of the FOVs would not interact with the recycler.

To avoid this problem, e.g., out-coupling the same FOV at different angles, the secondary grating vectors can have resulting momentum shifts that lie outside of the outer circle 701. As depicted in plot 700b, the k-vector K_{AR} 710 of the secondary grating also translates the FOV 700 from the annulus between inner and outer circles 701 and 703 outside of the outer circle 701. However, neither negative version of k-vectors k₁ 712 and k₂ 713, e.g., k-vector 714, can translate the FOV back within the outer circle 701 representing the permissible k-vectors for propagating within the substrate with an index of refraction of n=2. Accordingly, in some implementations, the secondary grating vector can have a minimum pitch to ensure that light that interacts with the secondary grating does not end up out-coupled at an incorrect angle. For example, the pitch of the secondary grating can be less than the pitch of the primary grating by a factor of at least two times the index of refraction of the substrate, since the index of refraction of the substrate determines the size of the outer circle 701.

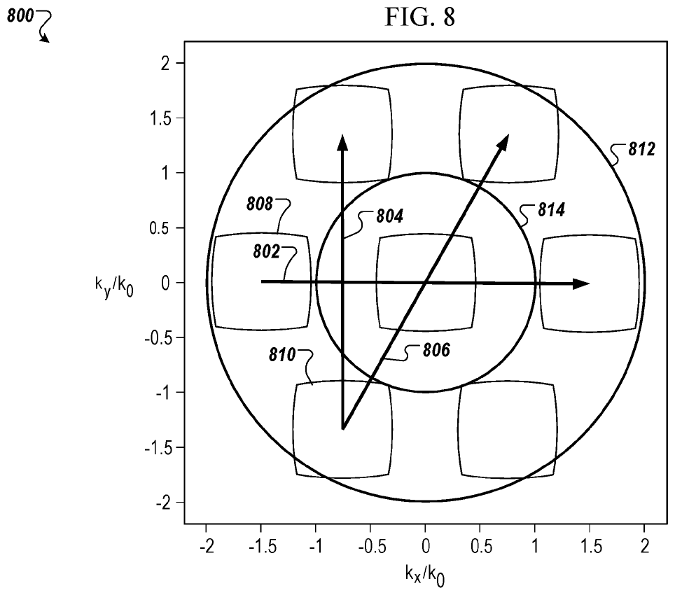

FIG. 8 depicts a plot 800 representing the effect of different morphed gratings on the momentum of light traveling in the eyepiece, according to an implementation of the present disclosure. Another way to avoid the problem of out-coupling the same FOV at different angles is to choose secondary grating vectors that are linear combinations of the primary grating vectors k₁ and k₂. For example, secondary grating vector 802 is equal to k₁+k₂, secondary grating vector 804 is equal to k₁−k₂, and secondary grating vector 806 is equal to 2×k₁ (k₁, k₂ of FIGS. 7A and 7B). As depicted in plot 800, the secondary grating vectors 802, 804, and 806 translate FOVs 808 and 810 to another value within the annulus between the inner and outer circles 812 and 814. In other words, choosing secondary grating k-vectors to be linear combinations of the primary grating k-vectors ensures that the resulting momentum from interacting with the morphed grating shift lies outside the inner circle. For example, in direct space, this translates to the design choice to make the length of the secondary grating. As a result, only FOVs propagating at the correct angle out-couple. Further, if the pitch of the secondary gratings is less than the wavelength, the secondary grating also functions as an antireflective grating, thereby improving transmission and reducing back-reflection.

### 2.1 Simulations-Based Evidence of Transmission Improvement and Back-Reflection Mitigation

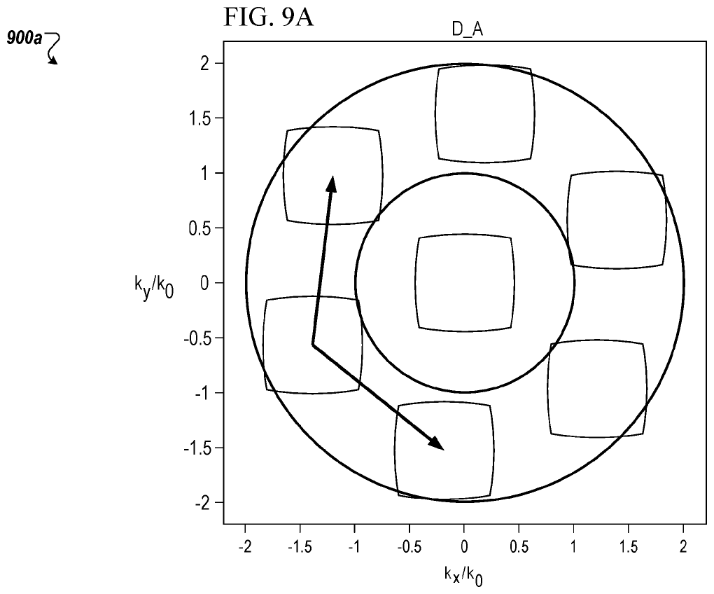

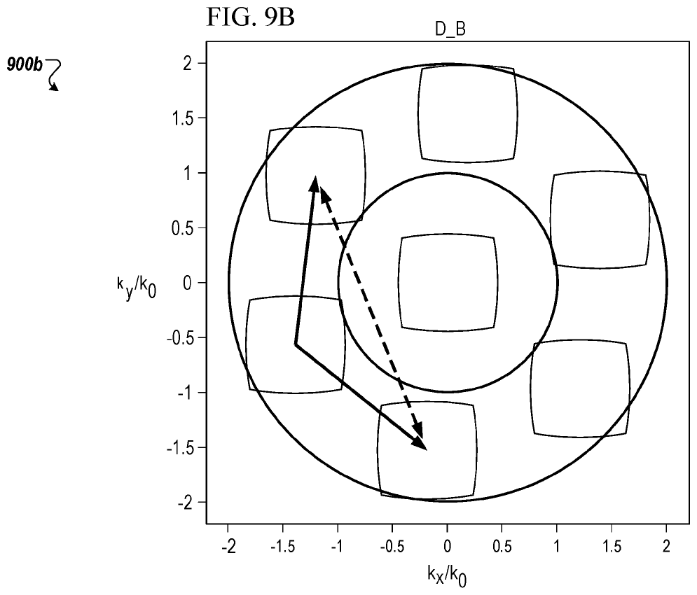

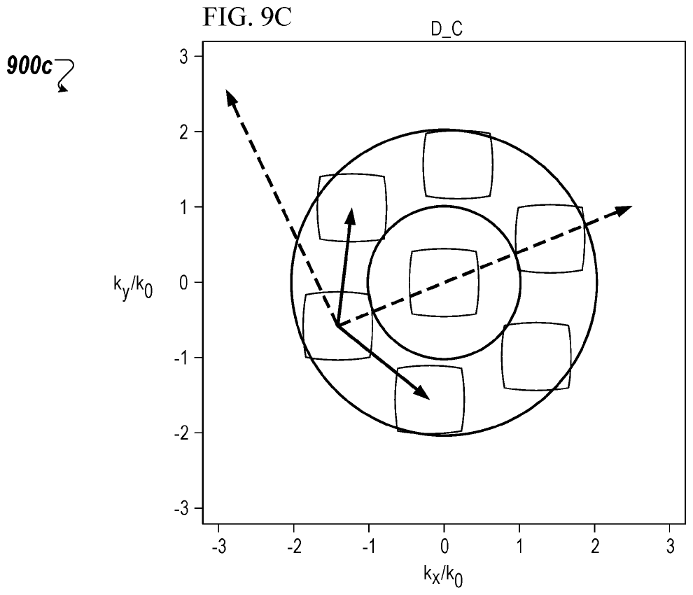

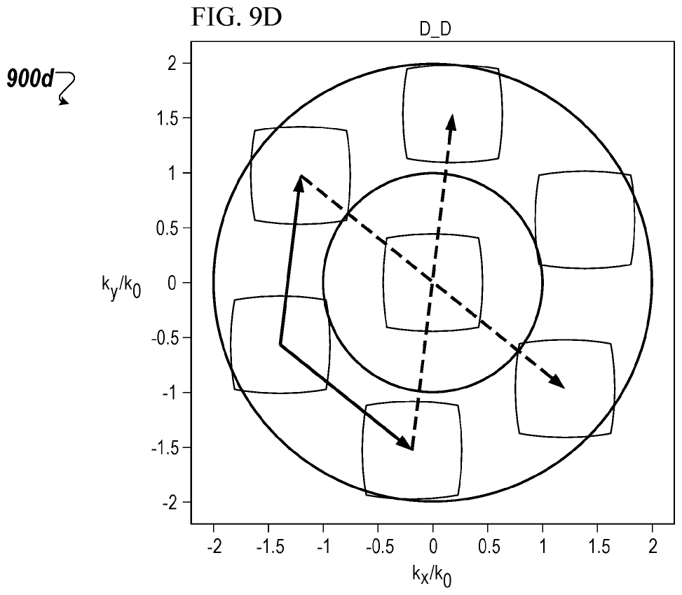

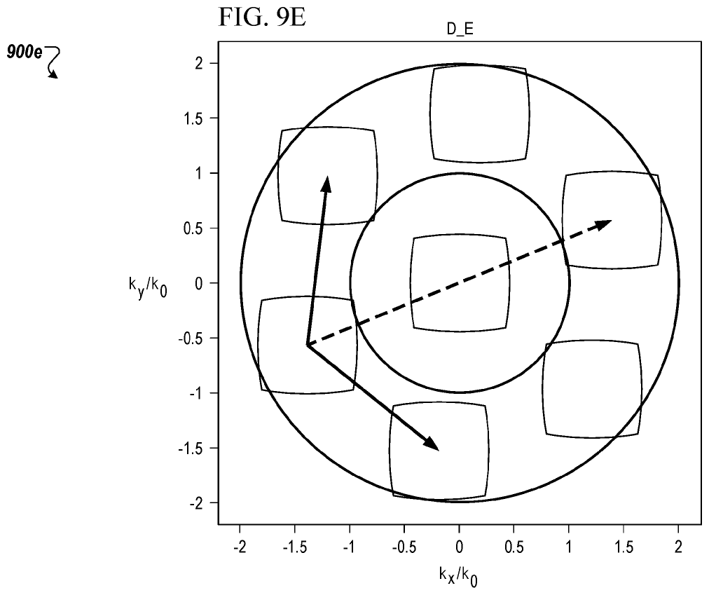

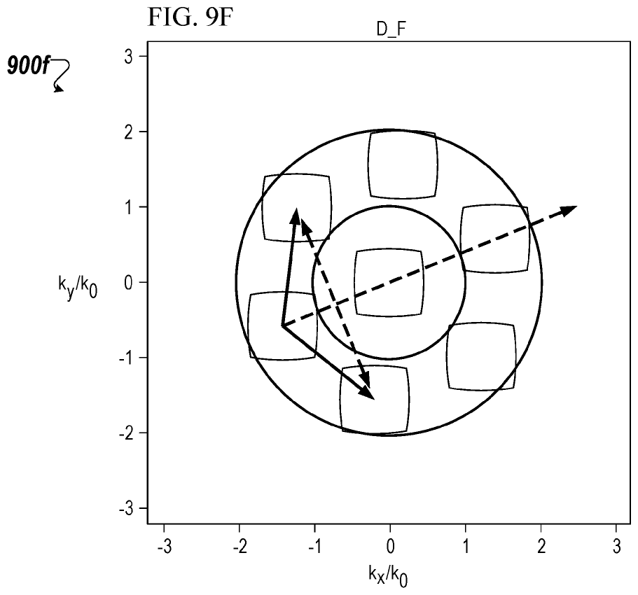

FIGS. 9A-9F depicts plots 900a-900f representing the effect of morphed gratings on the wave vector of light traveling in the corresponding eyepieces, according to an implementation of the present disclosure. In each of plots 900b-900f, the solid lines represent the k-vectors of the primary grating. In each of plots 900b-900f, the dashed lines represent the k-vectors of the secondary grating. Plot 900a represents an eyepiece without a secondary grating.

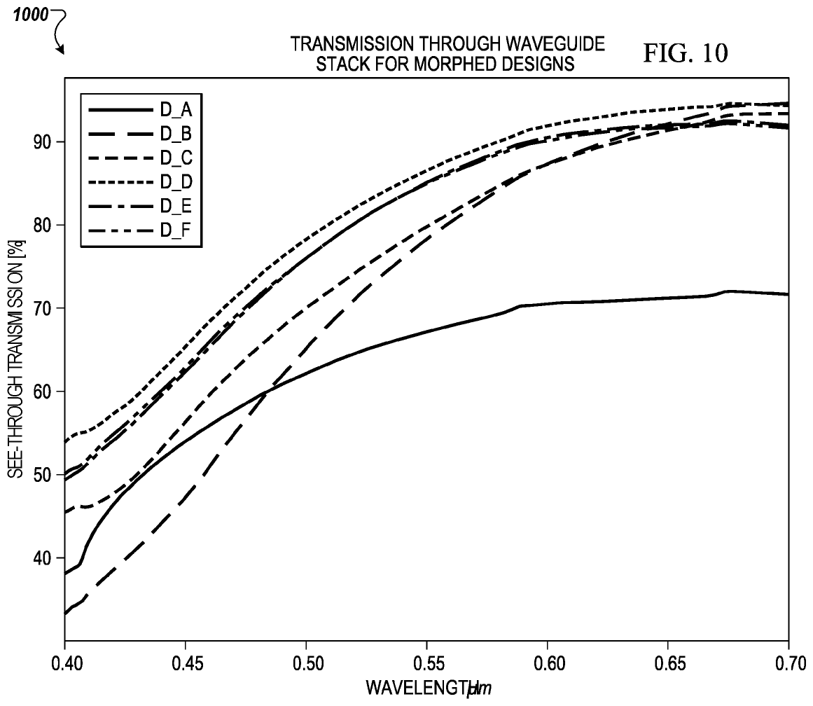

FIG. 10 depicts a plot 1000 of the simulated transmission profiles of the eyepieces from FIGS. 9A-9F versus wavelength, according to an implementation of the present disclosure. In FIG. 10, the light is incident from the world at an angle of 10°, some of which reflects back to the world and some of which transmits to the user. Each of the profiles D_A, D_B, D_C, D_D, D_E, and D_F corresponds to the grating k-vectors of FIGS. 9A-9F, respectively. The eyepiece without a secondary grating has the lowest transmission for most of the visible wavelength range, e.g., λ>0.5 micron. Thus, in general, including one of the secondary gratings represented by FIGS. 9B-9F improves, e.g., increases, the transmission of the eyepiece.

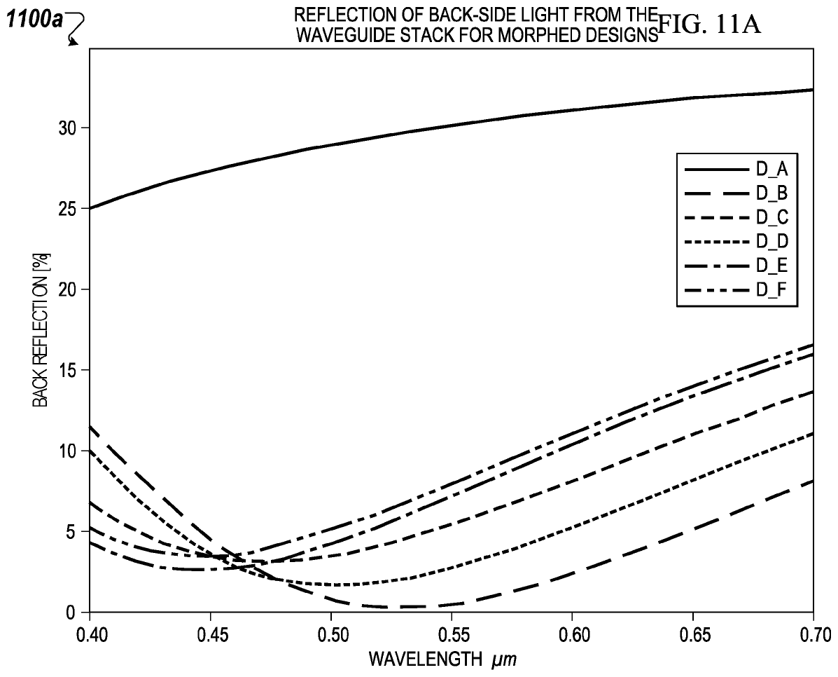

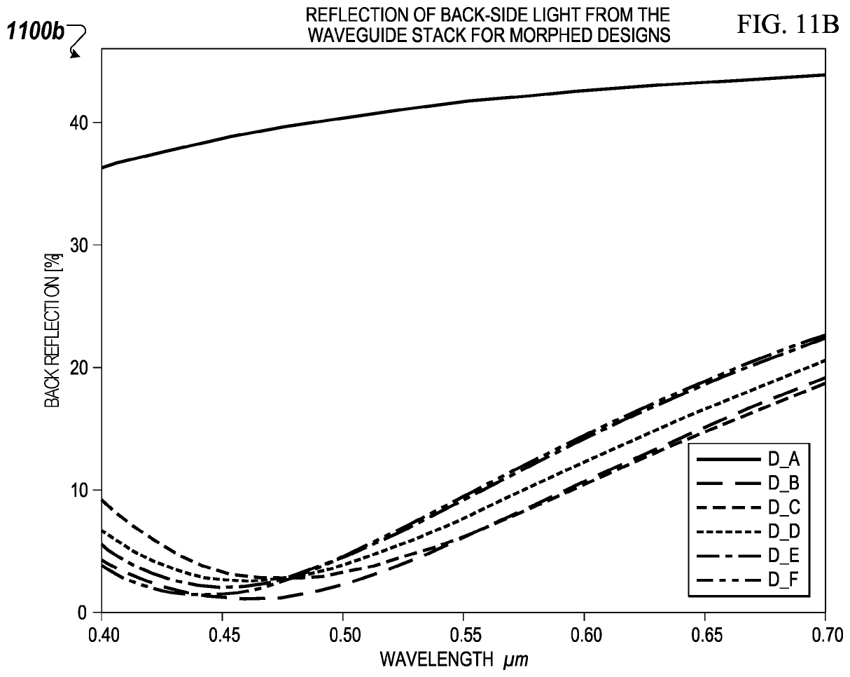

FIGS. 11A and 11B depict plots 1100a and 1100b, respectively, of the simulated reflectance profiles of the eyepieces from FIGS. 9A-9F versus wavelength for TM and TE polarized light, respectively, according to an implementation of the present disclosure. In plots 1100a and 1100b, the light is incident from the user side at an angle of 30°, some of which reflects back to the user and some of which transmits to the world. Each of the profiles D_A, D_B, D_C, D_D, D_E, D_F corresponds to the grating vectors of FIGS. 9A-9F, respectively. The eyepiece without a secondary grating has the highest reflectance profile across the entire wavelength range. Thus, including one of the secondary gratings represented by FIGS. 9B-9F improves, e.g., decreases, the back-reflection of the eyepiece. The combined effects illustrated by FIGS. 10, 11A, and 11B on the transmission to reflectance ratio can increase the ratio by up to 10 times compared to eyepieces without morphed gratings.

In some implementations, the light projection system has three channels, e.g., R, G, and B. Accordingly, each active layer, e.g., the layer of the morphed grating for particular channel, can be tuned according to the reflectance and transmission profile as a function of wavelength. For example, the morphed grating for the red channel can have different parameters, e.g., pitch, shape, height, and orientation, compared to the morphed grating for the blue channel.

In some implementations, the transmission profile of an eyepiece can increase with just a single active layer of a morphed grating.

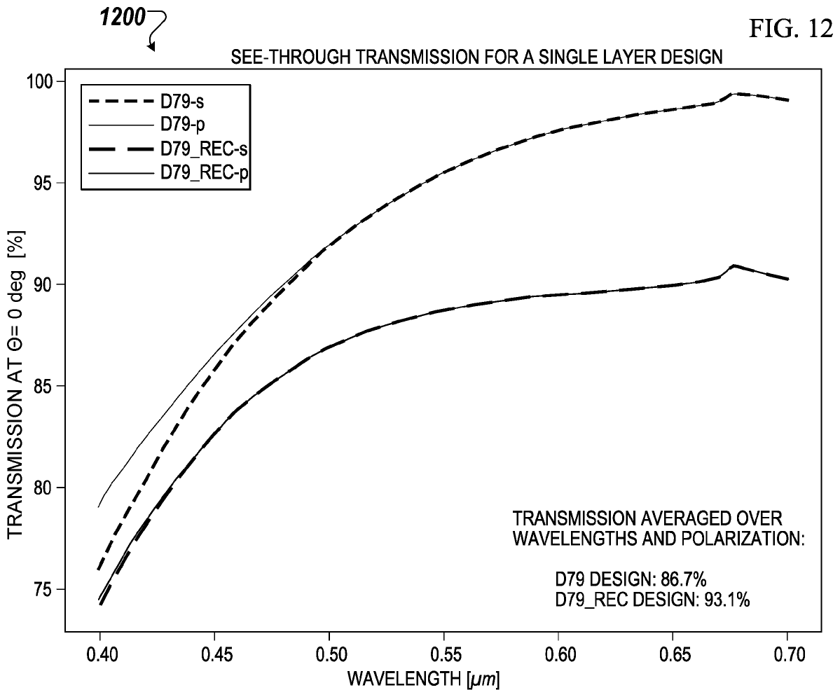

FIG. 12 depicts a plot 1200 of the transmission versus wavelength for eyepieces with and without a recycler, e.g., “D79” and “D79_REC,” for both s- and p-polarized light at normal incidence, according to an implementation of the present disclosure. As indicated by the plot, the transmission increases or both types of polarization when there is a morphed grating, a primary grating combined with a recycler. The average transmission over all wavelengths and polarizations for the eyepiece without the morphed grating is 86.7%, while the average is 93.1% for the eyepiece with the morphed grating.

FIGS. 10, 11A, 11B, and 12 were generated using simulation software. The simulation software approximates how the morphed gratings influence the display performance. The software handles full ray-tracing of all angles of incidence to simulate the display performance of the eyepiece. Based on ray-tracing simulation using fundamental Maxwell's equations, the efficiency distribution for different angles of incidence within the FOV can be analyzed.

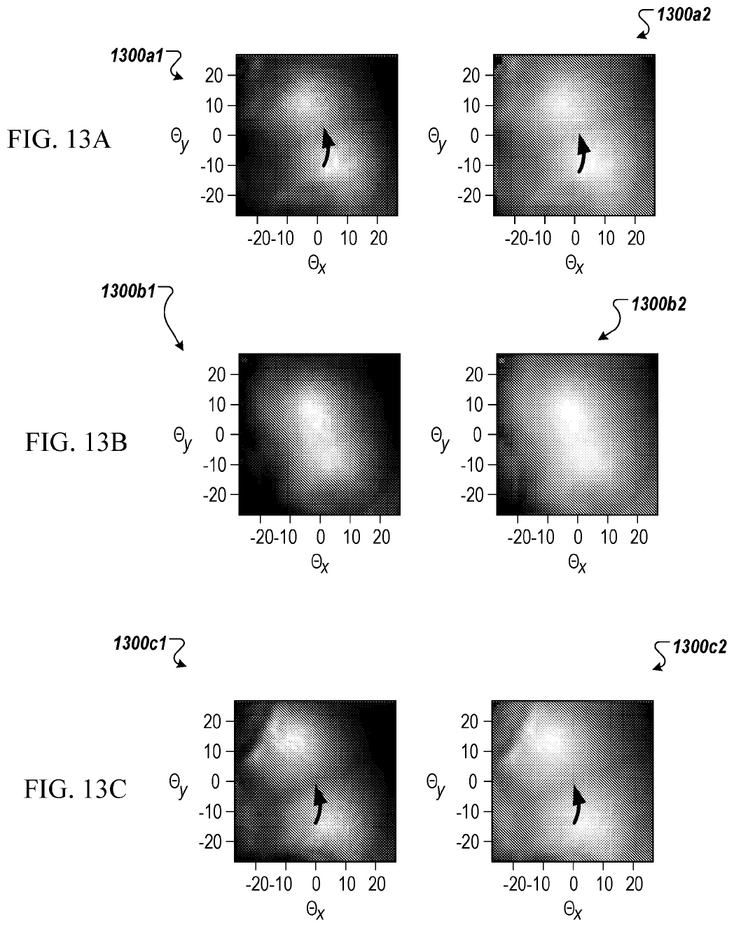

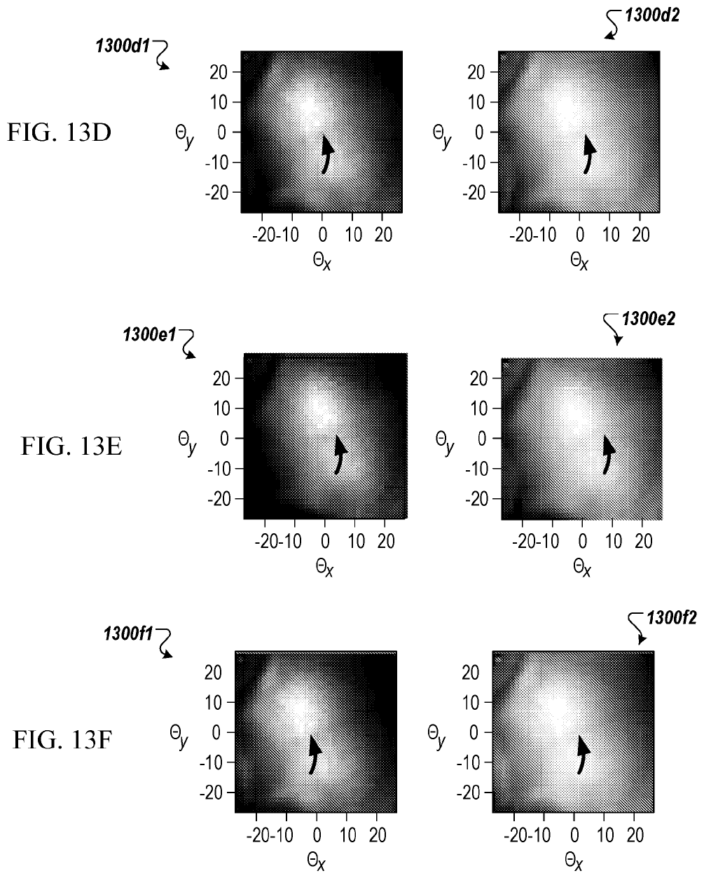

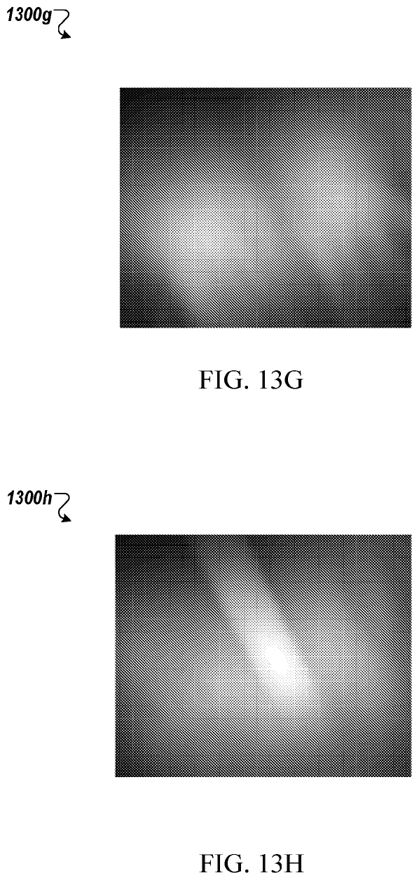

FIGS. 13A-13F depict the far-field efficiency distribution patterns 1300a1-1300f2 for a large FOV associated with the eyepieces from FIGS. 9A-9F, respectively, according to an implementation of the present disclosure. The FOVs represented in FIGS. 13A-13F span 53° by 53°.

Performance indicators associated with the FOV are the overall efficiency of the emission on the user side (U_{EBE}) as well as the world side (W_{EBE}), the uniformity score for 80% of the FOV (Uᵢₙₙₑᵣ₈₀) and for the full FOV (U_{fov}). The uniformity score is the ratio of the difference between the values 80^{th} and 20^{th} percentile to the value at the 50^{th} percentile (median). The distribution pattern on the left is a raw image, and the second of the distribution patterns on the right is Gamma corrected, which reduces contrast. A center-to-peak (CP) ratio, e.g., the value at the center divided by the maximum efficiency within the full FOV, can characterize the uniformity of the patterns. For example, the ideal CP ratio for an AR image can be 1, and the CP ratio for pattern 1300a2 is 0.62.

For pattern 1300a1, U_{EBE}=4.66%, W_{EBE}=4.63%, Uᵢₙₙₑᵣ₈₀=1.610, and U_{fov}=2.954. For pattern 1300b1, U_{EBE}=3.91%, W_{EBE}=3.13%, Uᵢₙₙₑᵣ₈₀=1.856, and U_{fov}=3.847. For pattern 1300c1, U_{EBE}=3.90%, W_{EBE}=3.32%, Uᵢₙₙₑᵣ₈₀=1.423, and U_{fov}=2.704. For pattern 1300d1, U_{EBE}=2.49%, W_{EBE}=2.13%, Uᵢₙₙₑᵣ₈₀=1.352, and U_{fov}=2.552. For pattern 1300e1, U_{EBE}=2.98%, W_{EBE}=3.1119%, Uᵢₙₙₑᵣ₈₀=1.659, and U_{fov=3.119}. For pattern 1300f1, U_{EBE}=3.67%, W_{EBE}=3.13%, Uᵢₙₙₑᵣ₈₀=1.291, and U_{fov}=2.704.

In patterns 1300b1-1300f1, the efficiencies U_{EBE} and W_{EBE} are slightly reduced compared to those of pattern 1300a1, e.g., by ˜1-2%. The uniformities Uᵢₙₙₑᵣ₈₀ and U_{fov} of patterns 1300c1, 1300d1, and 1300f1 are reduced compared to pattern 1300a1, while those of patterns 1300b1 and 1300e1, as indicated by the dark band marked by an arrow in each of FIGS. 13A-13F being more pronounced in FIGS. 13A and 13C-13F compared to FIGS. 13B and 13E. So although there are some drawbacks in terms of uniformity and efficiencies with certain morphed gratings, the drawbacks can be mitigated while improving the transmission and reflectance, discussed in relation to FIGS. 10, 11A, 11B, and 12.

In some implementations, using a morphed grating, e.g., the eyepiece from FIG. 9B, can improve the uniformity. For example, the efficiency distribution in FIG. 13B has fewer high frequency artifacts, e.g., the dark band, compared to FIG. 13A and FIGS. 13C-13F. In some implementations, a high-index eyepiece with a morphed grating can transmit 10% more light over visible wavelengths, e.g., be more transparent, than a high-index eyepiece without a morphed grating. Accordingly, using the morphed grating of FIG. 9B can improve uniformity while also improving transmission and back-reflection characteristics.

In some implementations, using a morphed grating can improve virtual image quality.

FIGS. 13G and 13H depict virtual image uniformities for control and morphed grating eyepieces, respectively, according to an implementation of the present disclosure. In this example, green light from a projector creates virtual images 1300g and 1300h. Virtual image 1300h is generally brighter and more uniform than virtual image 1300g, demonstrating that using morphed gratings can improve virtual image quality.

### 2.2 Manufacturing Process Examples for Combinatory Morphed Gratings

Templates for eyepieces with combined primary and secondary gratings, e.g., morphed gratings, can be fabricated using imprint lithography technology, e.g., jet and flash imprint lithography (J-FIL). Then, these templates can be used to further replicate morphed surface relief gratings onto high index waveguide substrates using imprint lithography processes.

FIGS. 14A-14F depict schematics of an example of a fabrication process for a morphed grating, according to an implementation of the present disclosure. As a first example, nano-imprinted primary and secondary gratings can be used directly as etch masks for transferring morphed geometries into a polymer, e.g., to form an imprint patterned polymer. In some implementations, the etching is full, conformal, directional, or planarized etching. In some implementations, the polymer includes a high-index non-filler-based polymer with an index of refraction less than 1.8. In some implementations, the polymer includes a high-index filler-based polymer with an index of refraction in a range between 1.8 and 2.1.

In FIGS. 14A-14F, the fabrication process starts with using lithography for patterning a first grating, which can be the smaller pitch grating, e.g., the secondary grating 604 of FIG. 6, at a particular orientation with a lithography and etch process. In FIG. 14A, a first pattern 1404 is deposited onto a template substrate 1402. In FIG. 14B, the first pattern 1404 is etched into the template substrate 1402, thereby forming a template for the secondary grating. In FIG. 14C, a second pattern 1406 is deposited onto the template substrate 1402. In FIG. 14D, the second pattern 1406 planarized over and etched into the template substrate 1402. In FIG. 14E, the second pattern 1406 is removed from the template substrate 1402, thereby forming the template substrate for a morphed grating 1412a, e.g., a grating having features from both the primary and secondary gratings of different parameters, indicated by the dashed box.

In some implementations, the step in FIG. 14F follows, which includes creating an inverse tone 1408, e.g., a template with inverse features compared to the template substrate 1402, with a morphed grating 1412b indicated by the dashed box. Creating an inverse tone can be carried out using nanoimprint lithography. In some implementations, the inverse tone 1408, copies of the final template substrate 1402, or both can be patterned into a material with a high index of refraction, such as high-index glass, lithium niobate, titanium oxide, and silicon nitride. Using a substrate with a high index of refraction can lead to an expanded FOV, as the refractive index of the substrate determines the range of permissible wave vectors.

The etch stop, e.g., depth at which etching ends, can determine a resist layer thickness (RLT) 1410. In some implementations, having a thin, e.g., less than 50 nm, RLT 1410 can be beneficial. For example, if RLT 1410 is sufficiently thin, e.g., less than 20 nm, it is easier to transfer the pattern of the template substrate 1402 into a high index material since there is no need to etch completely through the areas of thin RLT. This allows for nonmatching indices of refraction between the template substrate and the material forming the morphed grating, but retains the benefits of the shape of the morphed grating. In some implementations, as depicted in FIG. 14D, the RLT 1410 is an interconnecting RLT, e.g., connects neighboring ridges 1401a and 1401b of the morphed grating. In some implementations, the etch stop is selected such that an entire vertical portion of the first pattern, second pattern, or both is removed, as depicted in FIG. 14D, where the second pattern 1406 has discontinuous portions.

In some implementations, the first pattern 1404, e.g., a primary grating, and the second pattern 1406, e.g., a secondary grating, can have different pitches, e.g., different duty cycles, line width gradations, or both. For example, the first pattern 1404 can have a pitch P₁ and first line width LW₁, and the second pattern 1406 can have a second pitch P₂ and second line width LW₂. In this example, the first line width LW₁ is less than the second line width LW₂, and the first pitch P₁ is less than the second pitch P₂, but other variations are possible.

FIGS. 15A-15F depict schematics of an example of a fabrication process, using an intermediate masking layer, for a morphed grating, according to an implementation of the present disclosure. As another example, nano-imprinted primary and secondary gratings can be used along with an intermediate masking layer for transferring morphed geometries. In FIG. 15A, a first pattern 1502 for the secondary grating is imprinted on the intermediate masking layer 1504 on top of a substrate 1506. In some implementations, the intermediate masking layer 1504 includes chromium. In some implementations, the substrate 1506 includes silicon dioxide over silicon, e.g., thermal oxide silicon, or fused silica.

In FIG. 15B, the secondary grating, e.g., grating with a smaller pitch, is imprinted into the intermediate masking layer 1504. Then, in FIG. 15C, a second pattern 1508 for the primary grating is imprinted on top of remaining portion of the intermediate masking layer 1504 and substrate 1506.

FIG. 15D depicts etching using the second pattern 1508 for the primary grating. FIG. 15E depicts the substrate after removing the remaining portion of the second pattern 1508 and remaining portion of the intermediate masking layer 1504, thereby forming the final template 1510. While FIG. 15E depicts a cross-sectional view of the final template 1510, FIG. 15F depicts a plan view of the final template 1510.

In some implementations, the remaining intermediate layer can be left behind and determine a height of an additional grating, e.g., a recycler, in the final imprint. In some implementations, electron beam lithography is used throughout FIGS. 15A-F. In some of whom implementations, a combination of imprint lithography and etching yields sharp defined corners and edges of two-dimensional patterned holes and pillars.

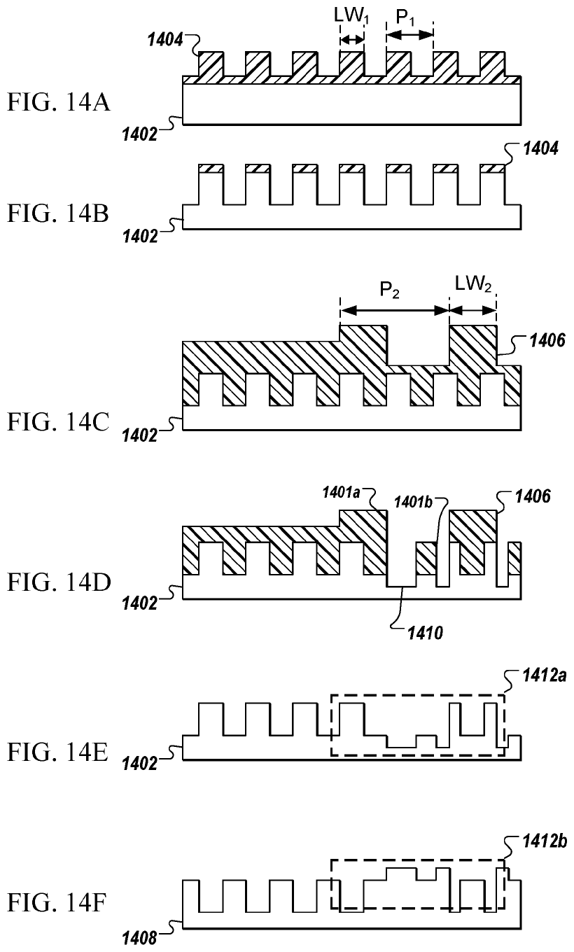

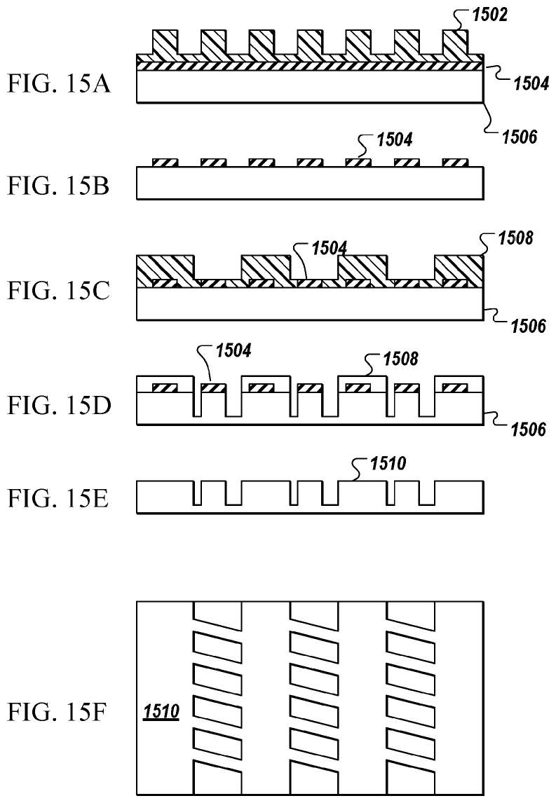

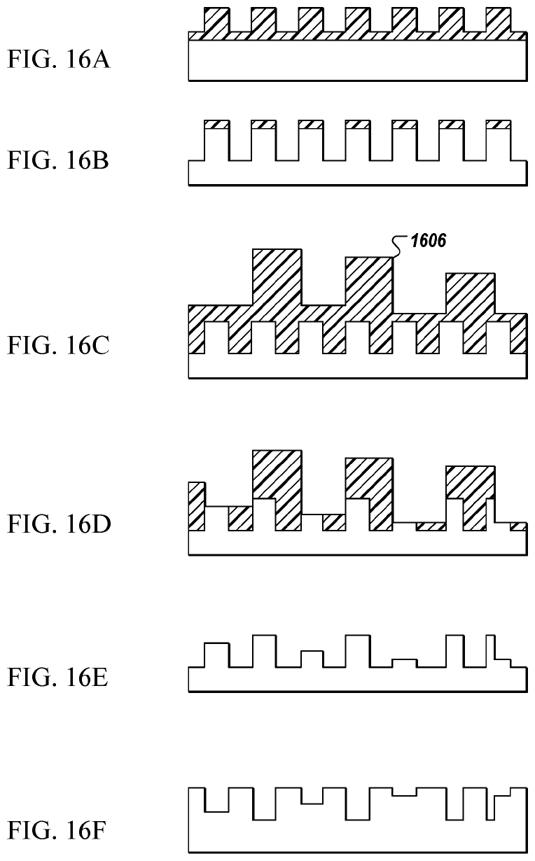

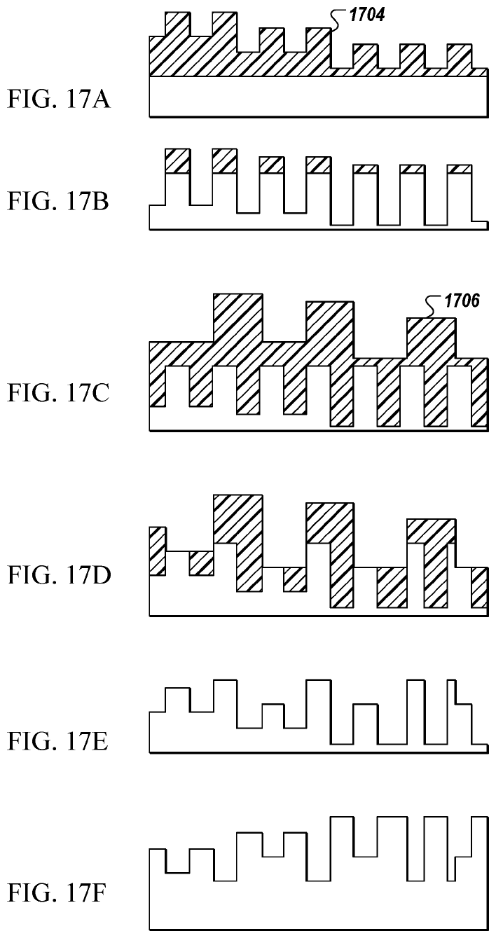

Processes such as J-FIL inkjet lithography can fabricate templates with analog or zoned gradation levels and have varying gradation axes. In some implementations, such as when using a J-FIL process with graded residual layer thickness (RLT) using inkjet dispense, it is possible to pattern transfer a graded design in either a first grating lithography-etch step, a second grating lithography-etch step (as in FIGS. 16A-16F), or in both (as in FIGS. 17A-17F).

FIGS. 16A-16F depict schematics of an example of a fabrication process for a morphed grating with a graded primary grading, according to an implementation of the present disclosure. The steps of FIGS. 16A-16F are similar to those of FIGS. 14A-14F, except that the primary grating, e.g., the second pattern 1606, is graded instead of having a constant height like second pattern 1406.

FIGS. 17A-17F depict schematics of an example of a fabrication process for a morphed grating where both the primary and secondary gratings are graded, according to an implementation of the present disclosure. The steps of FIGS. 17A-17F are similar to those of FIGS. 14A-14F, except that the primary grating, e.g., the second pattern 1706, and the secondary grating, e.g., first pattern 1704, are graded instead of having a constant height like first and second patterns 1404 and 1406.

This fabrication process can also accommodate morphing blazed geometries other than binary gratings, such as slanted, sawtooth, blazed sawtooth, multi-stepped, meta structure, cylinders, slanted cylinders, holes, slanted holes, trapezoidal cubes, cubes, cuboids, and other shapes.

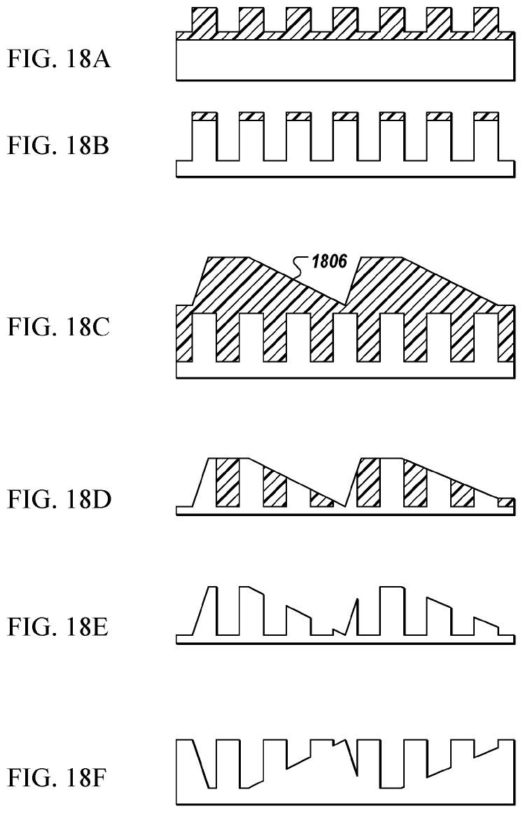

FIGS. 18A-18F depict schematics of an example of a fabrication process for a morphed grating where the primary grating is a sawtooth grating, according to an implementation of the present disclosure. The steps of FIGS. 18A-18F are similar to those of FIGS. 14A-14F, except that the primary grating, e.g., the second pattern 1806, has a sawtooth shape instead of a binary shape like second pattern 1406. Using a sawtooth shape for the primary grating can improve the user to world light extraction ratio by outcoupling more light towards the user, as well as maintaining high transmissivity.

All of the fabrication processes described in references to FIGS. 14A-18F can be carried out on both sides of a substrate, e.g., world-side and user-side.

In some implementations, the gratings formed through fabrication processes described in references to FIGS. 14A-18F can be over-coated conformally or directionally with one or more layers of low-or high-index (1.45<n<2.7) materials. For example, etching can create trench openings in the morphed grating, e.g., above where the RLT 1410 is labelled in FIG. 14D and between neighboring ridges 1401a and 1401b. In some implementations, the grating is over-coated with material with an index of refraction in a range of 1.15 to 2.1, e.g., organic sol-gel material or flowable Si₃N₄, to at least partially fill the trench openings. In some implementations, the maximum thickness of the over-coating layer can be between 500 nm and 10 micron. In some implementations, the over-coating at least partially covers the CPE, the OPE, the EPE, or a combination thereof, on either or both sides of the substrate.

### 3.0 Case 3: Stacked Gratings with Multiple Indices of Refraction

A third approach is to stack gratings of different indices of refraction. For example, a high-index, primary, diffractive surface relief gratings can be etched or patterned using deposition, e.g., physical vapor deposition (PVD) and atomic layer deposition (ALD). The primary surface relief grating can include coatings of a high- or low-index material, such as TiO₂, SiC, SiO₂, Si₃N₄, and ZrO₂ (1.5<n<2.7) that can be planarized using nanoimprint lithography, and include a second grating (1.5>n>1.7), such as an AR or recycler pattern, or vice versa.

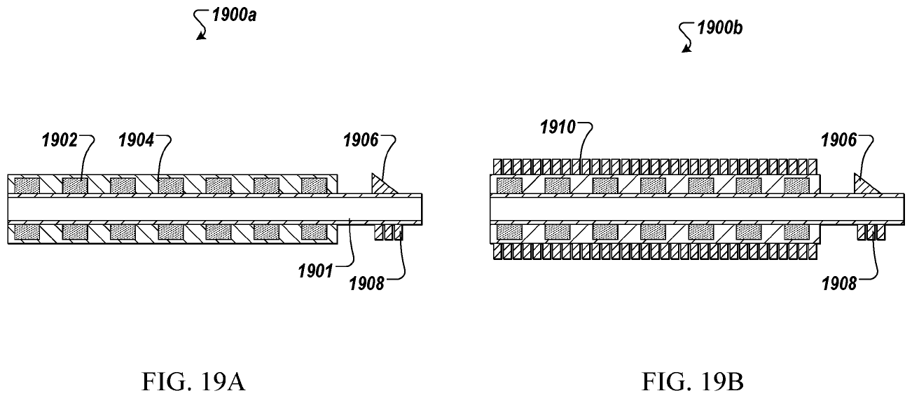

FIG. 19A depicts an example of an eyepiece including a secondary grating 1902, according to an implementation of the present disclosure. The secondary grating 1902 can include 1D or 2D CPE/OPE/EPE features, embedded within a lower index coated film 1904 on both sides of the substrate 1901. On a first side of the eyepiece 1900a is in ICG 1906, and an AR grating 1908 is on the opposite side of the eyepiece 1900a.

FIG. 19B depicts the eyepiece 1900b after a primary grating 1910 is stacked over the secondary grating 1902, according to an implementation of the present disclosure. Index modulation, e.g., the change in the index of refraction between the eyepiece 1900b and air, remains because the primary grating 1910 faces the air and has a lower index of material than that of the embedded secondary grating 1902. Stacking waveguides of different indices of refraction can allow for a more gradual change in the refractive index. For example, light from air can be incident a first grating with an index of refraction closer to 1 (reducing the difference in the index of refraction and thus back-reflection), and then light can travel from the first grating to a second grating with a large index of refraction, allowing for a large FOV. In some implementations, the primary grating 1910 is coated with a lower index material, such as MgF₂ (n=1.38) or SiO₂ (n=1.45), which can further improve the transmission and reduce back reflection.

In some implementations, as depicted in FIG. 19A, a first side of the eyepiece 1900b is proximal to a user, e.g., the side with the ICG 1906, and a second side of the eyepiece 1900b, e.g., the side with AR grating 1908 is distal to the user, e.g., the “world-side.” In some implementations, the first side of the eyepiece 1900b is distal to the user, e.g., the side with the ICG 1906, and a second side of the eyepiece 1900b, e.g., the side with AR grating 1908 is proximal to the user. Accordingly, the primary grating 1910 and the secondary grating 1902 can each be proximal, distal, or both (when the primary and secondary gratings are on both sides of the substrate) relative to the user.

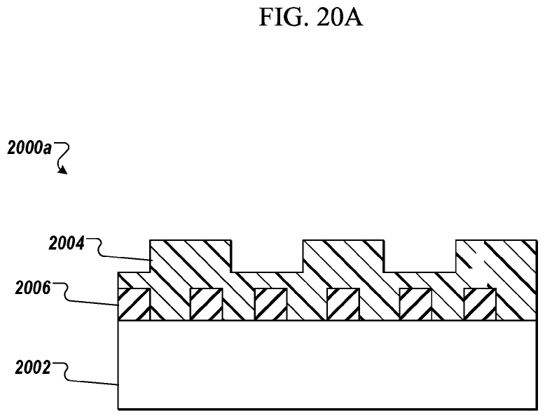

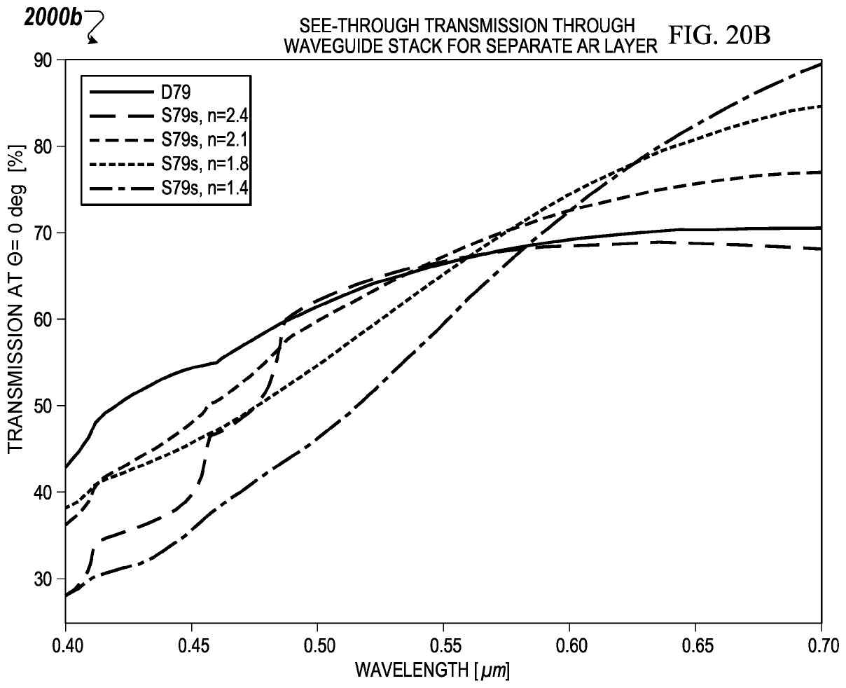

FIG. 20A depicts an example of a stacked grating 2000a, according to an implementation of the present disclosure. The stacked grating 2000a includes a substrate 2002, primary grating 2004, e.g., a CPE grating, and a secondary grating 2006, e.g., an AR grating. The substrate 2002 can have a high index of refraction, e.g., glass with n=2, the primary grating 2004 can have a first index of refraction, e.g., n₁=1.65, and the secondary grating 2006 can have a second index of refraction n₂.

FIG. 20B depicts a plot 2000b with the transmission profiles of the stacked grating 2000a for five versions of the second index of refraction as a function of wavelength, according to an implementation of the present disclosure. The light in FIG. 20B is at normal incidence and s-polarized. “D79” refers to when there is no secondary grating 2006, e.g., when the primary and secondary gratings 2004 and 2006 are made of the same material and thus have the same index of refraction, e.g., n₁=n₂=1.65. FIG. 20B shows the profile for n₂=2.4, 2.1, 1.8, and 1.4, e.g., n₂ being greater than and less than n₁.

The profiles of FIG. 20B show that the transmission of the stacked gratings, e.g., a primary grating stacked on the secondary grating with different indices of refraction, can approach the transmission of non-stacked surface relief gratings, e.g., D79, for wavelengths below ˜0.6 micron and be greater than the transmission of non-stacked surface relief gratings for wavelengths above ˜0.6 micron. In some implementations, a secondary grating having an index of refraction different from that of a primary grating can reduce rainbow artifacts when embedding the primary grating.

As described herein, there are various geometries for primary and secondary gratings for increasing transmission and reducing back-reflection, without sacrificing qualities of the display of digital content.

Although the present application is defined in the attached claims, it should be understood that the present invention can also (additionally or alternatively) be defined in accordance with the following examples:

Example 1: An eyepiece comprising:

a substrate;

an input coupling grating on a first side of the substrate; and

a morphed grating comprising characteristics of both a primary grating and a secondary grating on at least the first side of the substrate.

Example 2: The eyepiece of example 1, wherein the primary grating has two or more layers with two or more associated pitches and orientation, the two or more associated pitches and orientation determine two or more wave vectors and momentum space, the secondary grating has a pitch and orientation that determines a wave vector and momentum space, and the wave vector of the secondary grating is a linear combination of the two or more wave vectors of the primary grating.

Example 3: The eyepiece of either examples 1 or 2, wherein a pitch of the secondary grating is less than any pitch of the primary grating by a factor of at least two times an index of refraction of the substrate.

Example 4: The eyepiece of any of the preceding examples, wherein a pitch of the primary grating is different from a pitch of the secondary grating.

Example 5: The eyepiece of any of the preceding examples, wherein an orientation of the primary grating is different from an orientation of the secondary grating.

Example 6: The eyepiece of any of the preceding examples, wherein a shape of the primary grating is different from a shape of the secondary grating, and the shape of the primary grating and the shape of the secondary grating comprise portions with at least one of shapes from the group consisting of binary, slanted, blaze sawtooth, multi-step structures, meta structures, cylinders, holes, slanted holes, slanted cylinders, trapezoidal cubes, cube, and cuboids.

Example 7: The eyepiece of any of the preceding examples, wherein at least one of the primary and secondary gratings has a graded height profile.

Example 8: The eyepiece of any of the preceding examples, wherein an index of refraction of the primary grating is different from an index of refraction of the secondary grating.

Example 9: The eyepiece of any of the preceding examples, wherein the primary grating resides at least partially on one of an exit pupil expander, an orthogonal pupil expander, and a combined pupil expander.

Example 10: The eyepiece of any of the preceding examples, wherein the secondary grating is either a recycler or antireflective grating.

Example 11: The eyepiece of any of the preceding examples, wherein at least one of the primary and secondary gratings is one-dimensional.

Example 12: The eyepiece of any of the preceding examples, wherein at least one of the primary and secondary gratings is two-dimensional.

Example 13: The eyepiece of any of the preceding examples, wherein a pitch of the secondary grating is different from a pitch of the primary grating.

Example 14: The eyepiece of example 13, wherein the pitch of the secondary grating is less than the pitch of the primary grating.

Example 15: The eyepiece of any of the preceding examples, wherein a line width of the secondary grating is different from a line width of the primary grating.

Example 16: The eyepiece of any of the preceding examples, wherein the substrate has an index of refraction in a range from 1.5 to 2.7.

Example 17: The eyepiece of any of the preceding examples, wherein the primary grating includes a portion on a second side of the substrate opposite the first side of the substrate.

Example 18: The eyepiece of any of the preceding examples, wherein the first side of the substrate is proximal to a user, and the second side of the substrate is distal the user.

Example 19: The eyepiece of any of the preceding examples, wherein the first of the substrate is distal to a user, and the second side of the substrate is proximal the user.

Example 20: The eyepiece of any of the preceding examples, further comprising an anti-reflective grating on a second side of the substrate opposite the first side of the substrate.

Example 21: The eyepiece of any of the preceding examples, wherein at least one of the primary and secondary gratings was etched into the substrate.

Example 22: The eyepiece of any of the preceding examples, wherein at least one of the primary and secondary gratings was etched into a coating over the substrate.

Example 23: The eyepiece of example 22, wherein the coating is partially on at least one of the primary and secondary gratings.

Example 24: The eyepiece of example 23, wherein the coating has an index of refraction in a range from 1.45 to 2.7.

Example 25: The eyepiece of either examples 23 or example 24, wherein the coating comprises at least one of SiO₂, Si₃N₄, ZrO₂, TiO₂, or SiC.

Example 26: The eyepiece of either of any examples 23-25, wherein the coating at least partially fills trench openings in at least one of the primary and secondary gratings.

Example 27: The eyepiece of example 23, wherein the coating has an index of refraction in a range from 1.15 to 2.1.

Example 28: The eyepiece of either example 26 or example 27, wherein a maximum thickness of the coating is in a range from 500 nanometers to 10 micron.

Example 29: The eyepiece of any of examples 26-28, wherein at least one of the primary and secondary gratings comprises discontinuous portions.

Example 30: The eyepiece of any of examples 26-29, wherein etching of at least one of the primary and secondary gratings is at least one of partial, full, conformal, directional, or planarized.

Example 31: The eyepiece of any of examples 26-30, wherein etching of at least one of the primary and secondary gratings is on a side of the substrate proximal to a user, a side of the substrate distal to a user, or both.

Example 32: The eyepiece of any of the preceding examples, wherein at least one of the primary and secondary gratings was imprinted over the substrate with nanoimprint lithography.

Example 33: The eyepiece of example 32, wherein the eyepiece comprises a resist layer thickness of less than 50 nanometers.

Example 34: The eyepiece of either example 32 or example 33, wherein at least one of the primary and secondary gratings comprises an imprinted polymer consisting of a non-filler-based polymer with an index of refraction less than 1.8.

Example 35: The eyepiece of either example 32 or example 33, wherein at least one of the primary and secondary gratings comprises an imprinted polymer consisting of a filler-based polymer with an index of refraction in a range from 1.8 to 2.1.

Example 36: An eyepiece comprising:

a substrate;

an input coupling grating on a first side of the substrate; and

a stacked grating comprising a primary grating with a first index of refraction and a secondary grating with a second index of refraction, wherein the secondary grating is embedded within the primary grating, and the first and second indices of refraction are different.

Example 37: The eyepiece of example 36, wherein the second index of refraction is greater than the first index of refraction.

Example 38: The eyepiece of example 36, wherein the second index of refraction is less than the first index of refraction.

Example 39: The eyepiece of any of examples 36-38, wherein a pitch of the primary grating is different from a pitch of the secondary grating.

Example 40: The eyepiece of any of examples 36-39, wherein an orientation of the primary grating is different from an orientation of the secondary grating.

Example 41: The eyepiece of any of examples 36-40, wherein a shape of the primary grating is different from a shape of the secondary grating, and the shape of the primary grating and the shape of the secondary grating comprise portions with at least one of shapes from the group consisting of binary, slanted, blaze sawtooth, multi-step structures, meta structures, cylinders, holes, slanted holes, slanted cylinders, trapezoidal cubes, cube, and cuboids.

Example 42: The eyepiece of any of examples 36-41, wherein at least one of the primary and secondary gratings has a graded height profile.

Example 43: The eyepiece of any of examples 36-42, wherein the primary grating resides at least partially on one of an exit pupil expander, an orthogonal pupil expander, and a combined pupil expander.

Example 44: The eyepiece of any of examples 36-43, wherein the secondary grating is either a recycler or antireflective grating.

Example 45: The eyepiece of any of examples 36-44, wherein at least one of the primary and secondary gratings is one-dimensional.

Example 46: The eyepiece of any of examples 36-45, wherein at least one of the primary and secondary gratings is two-dimensional.

Example 47: The eyepiece of any of examples 36-46, wherein a pitch of the secondary grating is different from a pitch of the primary grating.

Example 48: The eyepiece of example 47, wherein the pitch of the secondary grating is less than the pitch of the primary grating.

Example 49: The eyepiece of any of examples 36-48, wherein a line width of the secondary grating is different from a line width of the primary grating.

Example 50: The eyepiece of any of examples 36-49, wherein the substrate has an index of refraction in a range from 1.5 to 2.7.

Example 51: The eyepiece of any of examples 36-50, wherein the primary grating includes a portion on a second side of the substrate opposite the first side of the substrate.

Example 52: The eyepiece of example 51, wherein the first side of the substrate is proximal to a user, and the second side of the substrate is distal the user.

Example 53: The eyepiece of example 51, wherein the first of the substrate is distal to a user, and the second side of the substrate is proximal the user.

Example 54: The eyepiece of any of examples 36-53, further comprising an anti-reflective grating on a second side of the substrate opposite the first side of the substrate.

Example 55: The eyepiece of any of examples 36-54, wherein at least one of the primary and secondary gratings was etched into the substrate.

Example 56: The eyepiece of any of examples 36-55, wherein at least one of the primary and secondary gratings was etched into a coating over the substrate.

Example 57: The eyepiece of example 56, wherein the coating of the at least one of the primary and secondary gratings is partial.

Example 58: The eyepiece of example 57, wherein the coating has an index of refraction in a range from 1.45 to 2.7.

Example 59: The eyepiece of either example 57 or example 58, wherein the coating comprises at least one of SiO₂, Si₃N₄, ZrO₂, TiO₂, or SiC.

Example 60: The eyepiece of any of example 57-59, wherein the coating at least partially fills trench openings in at least one of the primary and secondary gratings.

Example 61: The eyepiece of example 60, wherein the coating has an index of refraction in a range from 1.15 to 2.1.

Example 62: The eyepiece of either example 60 or example 61, wherein a maximum thickness of the coating is in a range from 500 nanometers to 10 micron.

Example 63: The eyepiece of any of examples 60-62, wherein at least of the primary and secondary gratings comprises discontinuous portions.

Example 64: The eyepiece of example any of examples 60-63, wherein etching of at least one of the primary and secondary gratings is at least one of partial, full, conformal, directional, or planarized.

Example 65: The eyepiece of any of examples 60-64, wherein etching of at least one of the primary and secondary gratings is on a side of the substrate proximal to a user, a side of the substrate distal to a user, or both.

Example 66: The eyepiece of any of examples 36-65, wherein at least one of the primary and secondary gratings was imprinted over the substrate with nanoimprint lithography.

Example 67: The eyepiece of example 66, wherein the eyepiece comprises a resist layer thickness of less than 50 nanometers.

Example 68: The eyepiece of either example 66 or example 67, wherein at least one of the primary and secondary gratings comprises an imprinted polymer consisting of a non-filler-based polymer with an index of refraction less than 1.8.

Example 69: The eyepiece of any of examples 66-69, wherein at least one of the primary and secondary gratings comprises an imprinted polymer consisting of a filler-based polymer with an index of refraction in a range from 1.8 to 2.1.

Example 70: An eyepiece comprising:

a substrate;

an input coupling grating on a first side of the substrate;

a primary grating on the first side of the substrate; and

a secondary grating on a second side of the substrate opposite the first side of the substrate, wherein a pitch of the secondary grating is less than a pitch of the primary grating.

Example 71: The eyepiece of example 70, wherein an orientation of the primary grating is different from an orientation of the secondary grating.

Example 72: The eyepiece of either example 70 or example 71, wherein a shape of the primary grating is different from a shape of the secondary grating, and the shape of the primary grating and the shape of the secondary grating comprise portions with at least one of shapes from the group consisting of binary, slanted, blaze sawtooth, multi-step structures, meta structures, cylinders, holes, slanted holes, slanted cylinders, trapezoidal cubes, cube, and cuboids.

Example 73: The eyepiece of any of examples 70-72, wherein at least one of the primary and secondary gratings has a graded height profile.

Example 74: The eyepiece of any of examples 70-73, wherein an index of refraction of the primary grating is different from an index of refraction of the secondary grating.

Example 75: The eyepiece of any of examples 70-74, wherein the primary grating resides at least partially on one of an exit pupil expander, an orthogonal pupil expander, and a combined pupil expander.

Example 76: The eyepiece of any of examples 70-75, wherein the secondary grating is either a recycler or antireflective grating.

Example 77: The eyepiece of any of examples 70-76, wherein at least one of the primary and secondary gratings is one-dimensional.

Example 78: The eyepiece of example any of examples 70-77, wherein at least one of the primary and secondary gratings is two-dimensional.

Example 79: The eyepiece of any of examples 70-78, wherein a line width of the secondary grating is different from a line width of the primary grating.

Example 80: The eyepiece of any of examples 70-79, wherein the substrate has an index of refraction in a range from 1.5 to 2.7.

Example 81: The eyepiece of any of examples 70-80, wherein the primary grating includes a portion on a second side of the substrate opposite the first side of the substrate.

Example 82: The eyepiece of example 81, wherein the first side of the substrate is proximal to a user, and the second side of the substrate is distal the user.

Example 83: The eyepiece of example 81, wherein the first of the substrate is distal to a user, and the second side of the substrate is proximal the user.

Example 84: The eyepiece of any of examples 70-83, further comprising an anti-reflective grating on a second side of the substrate opposite the first side of the substrate.

Example 85: The eyepiece of any of examples 70-84, wherein at least one of the primary and secondary gratings was etched into the substrate.

Example 86: The eyepiece of any of examples 70-85, wherein at least one of the primary and secondary gratings was etched into a coating over the substrate.

Example 87: The eyepiece of example 86, wherein the coating of the at least one of the primary and secondary gratings is partial.

Example 88: The eyepiece of example 87, wherein the coating has an index of refraction in a range from 1.45 to 2.7.

Example 89: The eyepiece of either example 87 or example 88, wherein the coating comprises at least one of SiO₂, Si₃N₄, ZrO₂, TiO₂, or SiC.

Example 90: The eyepiece of any of examples 87-89, wherein the coating at least partially fills trench openings in at least one of the primary and secondary gratings.

Example 91: The eyepiece of any of examples 87-90, wherein the coating has an index of refraction in a range from 1.15 to 2.1.

Example 92: The eyepiece of any of examples 87-91, wherein a maximum thickness of the coating is in a range from 500 nanometers to 10 micron.

Example 93: The eyepiece of any of examples 87-92, wherein at least of the primary and secondary gratings comprises discontinuous portions.

Example 94: The eyepiece of any of examples 87-93, wherein etching of at least one of the primary and secondary gratings is at least one of partial, full, conformal, directional, or planarized.

Example 95: The eyepiece of any of examples 70-94, wherein etching of at least one of the primary and secondary gratings is on a side of the substrate proximal to a user, a side of the substrate distal to a user, or both.

Example 96: The eyepiece of any of examples 70-95, wherein at least one of the primary and secondary gratings was imprinted over the substrate with nanoimprint lithography.

Example 97: The eyepiece of any of examples 70-96, wherein the eyepiece comprises a resist layer thickness of less than 50 nanometers.

Example 98: The eyepiece of example any of examples 70-97, wherein at least one of the primary and secondary gratings comprises an imprinted polymer consisting of a non-filler-based polymer with an index of refraction less than 1.8.

Example 99: The eyepiece of any of examples 70-98, wherein at least one of the primary and secondary gratings comprises an imprinted polymer consisting of a filler-based polymer with an index of refraction in a range from 1.8 to 2.1.

While this disclosure contains many specific implementation details, these should not be construed as limitations on the scope of any implementation of the present disclosure or of what may be claimed, but rather as descriptions of features specific to example implementations. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In addition, the processes depicted in the figures do not necessarily require the particular order shown, or sequential order, to achieve desirable results. While various implementations of the present invention have been described herein, it should be understood that they have been described as examples. Many variations and modifications may be apparent to those skilled in the art upon reading the specification. The breadth and scope of the present invention is not limited by the examples described herein, and can be interpreted broadly to include such variations and modifications.

1. An eyepiece comprising:
a substrate;
an input coupling grating on a first side of the substrate; and
a morphed grating comprising characteristics of both a primary grating and a secondary grating on at least the first side of the substrate,
wherein the primary grating has two or more layers with two or more associated pitches and orientation, the two or more associated pitches and orientation determine two or more wave vectors in momentum space, the secondary grating has a pitch and orientation that determines a wave vector in momentum space, and the wave vector of the secondary grating is a linear combination of the two or more wave vectors of the primary grating.

2. (canceled).

3. The eyepiece of claim 1, wherein a pitch of the secondary grating is less than any pitch of the primary grating by a factor of at least two times an index of refraction of the substrate.

4. (canceled).

5. (canceled).

6. (canceled).

7. (canceled).

8. The eyepiece of claim 1, wherein an index of refraction of the primary grating is different from an index of refraction of the secondary grating.

9. (canceled).

10. The eyepiece of claim 1, wherein the secondary grating is either a recycler or antireflective grating.

11. (canceled).

12. An eyepiece comprising:
a substrate;
an input coupling grating on a first side of the substrate; and
a morphed grating comprising characteristics of both a primary grating and a secondary grating on at least the first side of the substrate,
wherein at least one of the primary and secondary gratings is two-dimensional.

13. The eyepiece of claim 12, wherein a pitch of the secondary grating is different from a pitch of the primary grating.

14. The eyepiece of claim 13, wherein the pitch of the secondary grating is less than the pitch of the primary grating.

15. The eyepiece of claim 12, wherein a line width of the secondary grating is different from a line width of the primary grating.

16. (canceled).

17. The eyepiece of claim 12, wherein the primary grating includes a portion on a second side of the substrate opposite the first side of the substrate.

18. The eyepiece of claim 17, wherein the first side of the substrate is proximal to a user, and the second side of the substrate is distal the user.

19. The eyepiece of claim 17, wherein the first of the substrate is distal to a user, and the second side of the substrate is proximal the user.

20. The eyepiece of claim 1, further comprising an anti-reflective grating on a second side of the substrate opposite the first side of the substrate.

21. The eyepiece of claim 12, wherein at least one of the primary and secondary gratings was etched into the substrate.

22. (canceled).

23. An eyepiece comprising:
a substrate;
an input coupling grating on a first side of the substrate; and
a morphed grating comprising characteristics of both a primary grating and a secondary grating on at least the first side of the substrate,
wherein at least one of the primary and secondary gratings was etched into a coating over the substrate, and
wherein the coating is partially on at least one of the primary and secondary gratings.

24. (canceled).

25. (canceled).

26. The eyepiece of claim 23, wherein the coating at least partially fills trench openings in at least one of the primary and secondary gratings.

27. (canceled).

28. (canceled).

29. The eyepiece of claim 26, wherein at least one of the primary and secondary gratings comprises discontinuous portions.

30. (canceled).

31. The eyepiece of claim 26, wherein etching of at least one of the primary and secondary gratings is on a side of the substrate proximal to a user, a side of the substrate distal to a user, or both.

32. The eyepiece of claim 1, wherein at least one of the primary and secondary gratings was imprinted over the substrate with nanoimprint lithography.

33. The eyepiece of claim 32, wherein the eyepiece comprises a resist layer thickness of less than 50 nanometers.

34. The eyepiece of claim 32, wherein at least one of the primary and secondary gratings comprises an imprinted polymer consisting of a non-filler-based polymer with an index of refraction less than 1.8.

35. The eyepiece of claim 32, wherein at least one of the primary and secondary gratings comprises an imprinted polymer consisting of a filler-based polymer with an index of refraction in a range from 1.8 to 2.1.

36-99. (canceled).
